(19) United States
(12) Patent Application Publication
(10) Pub. No.: US 2015/0147729 A1
(43) Pub. Date: May 28, 2015

(54) Pile Manipulation Game

(71) Applicant: Marius Gerardus Jacobus Versteegen, Utrecht (NL)

(72) Inventor: Marius Gerardus Jacobus Versteegen, Utrecht (NL)

(21) Appl. No.: 14/087,013

(22) Filed: Nov. 22, 2013

(51) Int. Cl. G09B 23/02; G09B 5/02

(52) U.S. Cl. CPC G09B 23/02; G09B 5/02
USPC 434/188

(57) ABSTRACT

A system and method is provided that enables children to learn and practice number sense and basic numerical operations. In one embodiment, children are invited to move objects that represent units, as well as objects that represent tens, in order to visualize the process of solving basic numerical operations. The movements that are allowed are subject to restrictions and other special behavior, which help children to gain insight in the numerical processes of these basic numerical operations in such a way that a solid foundation is created that prepares them to solve these operations on a purely formal level in a later stage.

### CROSS-REFERENCE TO RELATED APPLICATIONS

This application claims the benefit of next two provisional patent applications by the present inventor:

1. Provisional patent application Ser. No. U.S. 61/749,649, filed 2013 Jan. 7th.
2. Provisional patent application Ser. No. U.S. 61/803,704, filed 2013 Mar. 20th.

### FEDERALLY SPONSORED RESEARCH

None

### SEQUENCE LISTING

None

### BACKGROUND

### Prior Art

The following is a tabulation of some prior art that presently appears relevant:

### U.S. Patent Application Publications

| Publication Nr. | Kind Code | Publ. Date | Applicant |
|---|---|---|---|
| 2010/0285437 | A1 | Nov. 11, 2010 | Radas |

### Nonpatent Documents

Content at Dec. 17, 2012 of the webpage: http://www.mikeaskew.net/page3/page4/files/NumeracyUserReview.pdf “How do we teach children to be numerate?”, A professional user review of UK research undertaken for the British Educational Research Association, by Mike Askew and Margaret Brown. This document was downloaded and can be found in next enclosed pdf: PriorArtHowDoWeTeachChildrenToBeNumerate.pdf
Content at Dec. 17, 2012 of the webpage: http://www.justmontessori.com/math/A snapshot of said content can be found in next enclosed pdf: PriorArtJustMontessori.pdf
Content at Dec. 19, 2012 of the webpage: http://www.ixl.com/math/grade-4/place-values A snapshot of said content can be found in next enclosed pdf: PriorArtIXLPlaceValues.pdf
Content at Nov. 10, 2012 of the webpage: http://www.costcuttersuk.com/bead_bars/beads_bar/155351_p.html A snapshot of said content can be found in next enclosed pdf: PriorArtCommerciallyAvailableBeadbar.pdf

This application relates to educational software that is used to shed insight into the principles of basic math operations. Some time ago, my five year old son, who was trying to teach himself some numerical skills, asked me a question: “Daddy, I forgot, how much again is 37 plus 15?”. At that point, I realized that he was trying to memorize the combinations, while for results that exceed ten, he should be aware of how to deal with digit overflows. I could learn him how to do it with the usual “trick” on paper (writing numbers below each other, first adding the least significant digit, administering an overflow if required, then the next, etc.), but from an educational point of view, that didn't appear very satisfactory. Rather than teaching my son a mere trick, I prefer to let him acquire insight, such that he understands what he's doing. Thus I searched the android market, the internet and the app store for educational software that would allow him to practice with exercises in a way that would give him that insight. I was quite astonished that most of the software just generated exercises, at best with numbers visualized by items that are grouped in ways that don't help to gain insight.

The software in Prior_Art_IXL_Place_Values.pdf does provide better grouping, which resembles the physical system of Prior_Art_Just_Montessori.pdf and some physical representations shown in prior art by Radas. However, for children that are just starting to learn the concepts of numbers and the principles of overflows, these groupings are not very intuitive. For instance, with those groupings, the number of 12 would be represented by lining up 10 cubic units along a line, while the next two are positioned along a line parallel to it. That kind of grouping makes it hard for a child to see that 12 is identical to 2 groups of 6, or 3 groups of four, etc. Furthermore, there is no intuitive support as to why the group size is supposed to be 10. Also, children need to make sure manually that subgroups of units that reach the size of 10, are replaced by larger objects that represent a value of 10. Because of that, counting and bookkeeping will ask for a lot of the attention of the child, and it will be able to give less attention to understand the numerical process of the exercises. Furthermore, as far as concerning the present relevant prior art that I managed to find, all require considerable effort from teachers to teach their pupils the rules of how to manipulate these groups to visualize mathematical operations.

Bead bar based games, like the physical game that is shown in Prior_Art_Commercially_Available_Beadbar.pdf may be more intuitive for children that just start to learn the concept of numbers, because the objects (beads) are organized in a single dimension only. However, if children are using the Beads to exercise addition or subtraction by moving beads back and forth, there is nothing that forces them to treat units and tens separately. To subtract an amount of 7, all they need to do is count 7 beads and shift them toward the right at once. Nothing is forcing them first to remove the units of the original number, and then opening up the next ten and shifting the remaining units. Even if the children realize that their shift is opening up a ten, the system is not providing a proper foundation for learning to solve formal exercises. For example, for these children subtraction 10 from 23 on a bead bar could easily be interpreted as a subtraction of 3, followed by breaking up of the second ten and subsequent subtraction of 7. So the nature of the bead bar tends to confuse children on when tens need to be broken.

The document “How do we teach children to be numerate?” on page 13 comes up with two conclusions 1: “Children need to be encouraged to develop efficient mental images and such a range will be influenced by physical representations offered by the teacher.” and 2: “Working in a structured and systematic way with a limited but effective set of representations may be more helpful than offering children a wide range of representations”. Thus, a need is formulated of which I am confident that it is fulfilled by the proposed embodiments of my pile manipulation game much better than by any relevant prior art that I am currently aware of.

### SUMMARY

A pile manipulation game that develops number sense and teaches mathematical principles in a more insightful and intuitive way to children than any prior art that I am currently aware of. The game provides its users the possibility to manipulate piles of rectangular shaped objects as an insight shedding way to perform mathematical exercises. All of these rectangular objects represent a predetermined numerical value (like for instance, the value 1). Each pile is associated with a numeric value that equals the amount of objects times the numerical value of each object, which is shown by digits that are displayed below the pile. The visualization of quantities is thus intuitive: a quantity is directly proportional to the height of a pile. It thus copies that advantage of the bead bar, which has its objects organized into a single dimension as well. From bottom upward, the objects within each pile are automatically delimited/grouped by square containers of approximately the same width. The predetermined height of the rectangular objects is chosen in such way, that an intuitive amount fits into a square container. For instance, in the case that a single rectangular object represents the value 1, a useful choice can be to make its height such that 10 of them would fit into a square container.

Thus, a pile can be interpreted as a pile of zero or more filled square containers, with optionally on top of it a pile of rectangular objects in a partially filled square container. Thus, double digit numbers are represented in an intuitive way. The most significant digit corresponds to the height of the pile of filled containers at the bottom, while the least significant digit corresponds to the height of the pile of rectangular objects in the partially filled container that is stacked on top of it. The display of these digits directly below the pile gives the user the opportunity to quickly understand these relationships. In addition, the pile can still be interpreted as a pile of rectangular objects, which gives a good sense of the total quantity that it represents.

The squareness of the container helps the children to intuitively accept as natural that a delimiter/container is drawn around 10 rectangular objects, not more, not less. That is because if you stack 10 of them, something special happens: the shape of that stack becomes point-symmetrical. Children will probably not recognize that consciously, but subconsciously, it will help them to accept in a natural way to accept that to exceed 10, a numerical overflow will be needed.

Count helpers in the form of dashed horizontal lines as part of the containers, as well as in the form of a diamond or other helpful shape displayed in front of the rectangular objects, provide geometrical references that help children to quickly count the amount of rectangular objects that a partially filled container holds, as well as the amount of free “slots” that are still left. By the structure they offer, after a little of practice, they enable the child to see at a glance what these amounts are, without the need of counting anymore, in a way analogous to reading the amount of dots from a dice.

Application of randomized multi-color dashed lines in the graphical representations of count helpers and containers softens up the rigid periodical nature of the grouping, and makes counting easier.

The containers and rectangular objects can be transferred from one pile to another pile by the user. The behavior of the user interface that supports these user initiated transfers is governed by a set of process rules. These software implemented rules accomplish next things: 1. It practically removes the need to teach the user how to make groups and how to geometrically organize them, because that's what the software does automatically for him. 2. It enforces restrictions to the user that encourages him to make transfers that coincide with recommended logical steps in the process of making mental calculations. For instance, when subtracting, first the topmost partially filled container must be transferred away from a pile (to another pile), before part of the container below can be transferred, encouraging the user to learn to follow logical steps that will turn out to be useful as at a later stage, when he will be making formal exercises. Furthermore, if a full container is transferred to another pile, it is inserted at the top of the stack of full containers that that pile already consist of, clarifying why adding a multiple of ten only influences the most significant digit of a two digit number. Apart from that, the process rules encourage use of the so called “sequenced” method, which is cited to be a preferred approach to deal with subtractions and additions (see “How do we teach children to be numerate?”, page 8). Thus children are encouraged to learn recommended ways of mental calculations in an intuitive an insightful way, lessening the amount of required teaching effort.

Animations are used in such a way that all rectangular objects move smoothly and are eye trackable. That helps to give the user a sense of control and understanding. For instance in the last case the partially filled container on top is animated to move upward when a full container is inserted below it. For the same reason (sense of control and understanding), while the user is performing a drag and drop action to transfer containers or rectangular objects, in the pile that these items originate from, ghost (transparent or milky) representations of these selected items are displayed until the drag and drop transfer is concluded. Thus, during the drag and drop operation, the user can judge and rethink the impact that his action will have, and based on that, decide to either abort or conclude it.

Additional means, like a reservoir location to draw new rectangular objects from, a style palette to define their appearance and a trash location where they can be destroyed, can be used by a teacher, for instance to set up a specific configuration of piles of rectangular objects for demonstration purposes, to be shown for instance on a smartboard or tablet device, or for the purpose of specifying a pile manipulation game such that one or more of his pupils can play it as a mathematical exercise.

### ADVANTAGES

Accordingly several advantages of one or more aspects are as follows: Children develop number sense and learn mathematical principles for double digit numbers in an insightful and intuitive way. In addition, they are encouraged to perform mental calculations using recommended methods. There are other advantages of one or more aspects. They will be apparent from a consideration of the drawings and ensuing description.

### DRAWINGS

### Figures

Many figures illustrate examples of graphical widgets for electronic display and the way they can be manipulated by the user. Specific names for these widgets and manipulations are defined only at their first occurrence in the detailed description. To make them easy to discern, a fairly arbitrary prefix “mv” (marius versteegen) is used for them.

Multiple instances of the same type of object are discerned by adding letter postfixes to their reference numerals. For instance mvCrate 600g is a specific instance of type mvCrate 600.

The number of the figure that introduces a graphical widget with a certain reference numeral can be found by omitting the two least significant digits, as well as the trailing letter, if any. In general, said graphical widget is introduced in the detailed description of said figure. For example, a specific mvCrate is indicated by reference numeral 600g. Consequentially, a detailed introduction of mvCrates in general can be found in the detailed description for FIG. 6.

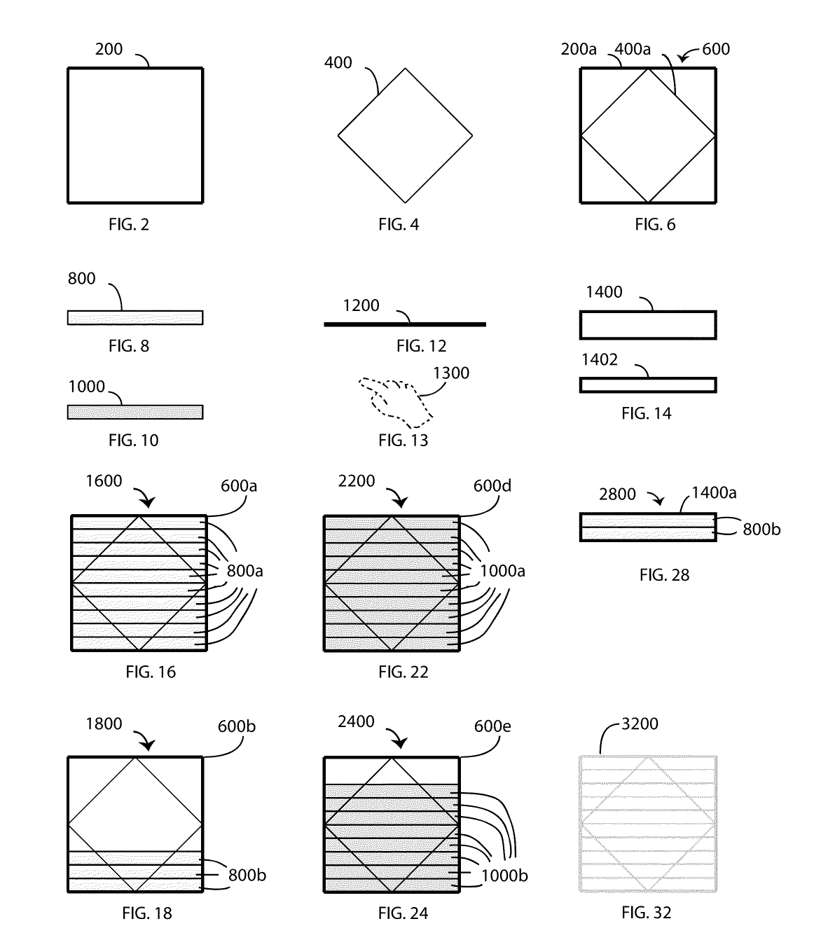

FIG. 2 shows an mvCrateDelimiter 200.

FIG. 4 shows an mvCountHelper 400.

FIG. 6 shows an mvCrate 600, comprising mvCrateDelimiter 200a and mvCountHelper 400a.

FIG. 8 shows a specific mvBarTenth 800 with a light color.

FIG. 10 shows a specific mvBarTenth 1000 with a dark color.

FIG. 12 shows an mvPileLocation 1200.

FIG. 13 shows an mvHandPointer 1300.

FIG. 14 shows a specific mvPackageDelimiter 1400 of size two, as well as a specific mvPackageDelimiter 1402 of size one.

FIG. 16 shows a specific mvCrate 1600 that is mvFull and comprises mvCrate 600a that is filled with ten mvBarTenths 800a.

FIG. 18 shows a specific mvCrate 1800, which comprises mvCrate 600b, containing three mvBarTenths of light color 800b.

FIG. 22 shows a specific mvCrate 2200, which is mvFull, and comprises mvCrate 600d, containing only mvBarTenths with dark color 1000a.

FIG. 24 shows a specific mvCrate 2400, which comprises mvCrate 600e, containing eight mvBarTenths of dark color 1000b.

FIG. 28 shows a specific mvPackage 2800 of size two.

FIG. 32 shows an mvCrateGhost 3200 of an mvFull mvCrate, filled with mvBarTenths.

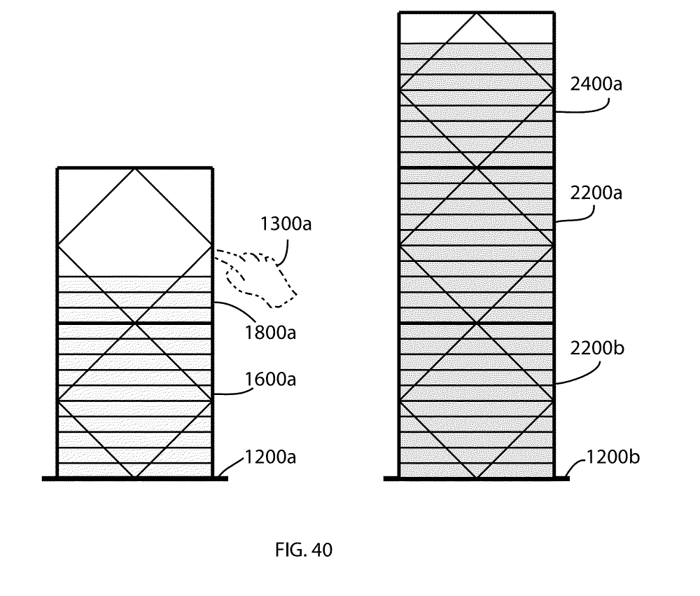

FIG. 40 illustrates the start of a user initiated drag of mvCrate 1800a, to transfer it from the left pile of crates to the right pile of crates.

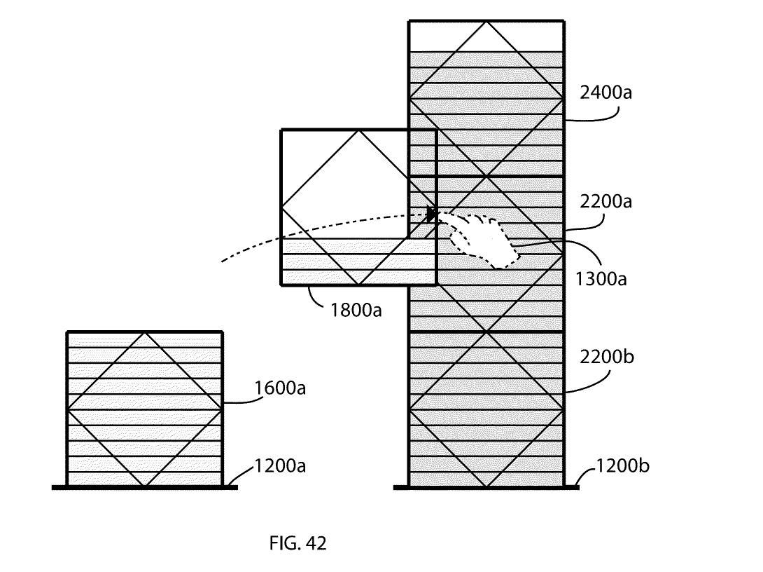

FIG. 42 illustrates the drag operation that was initiated in FIG. 40, while being in progress.

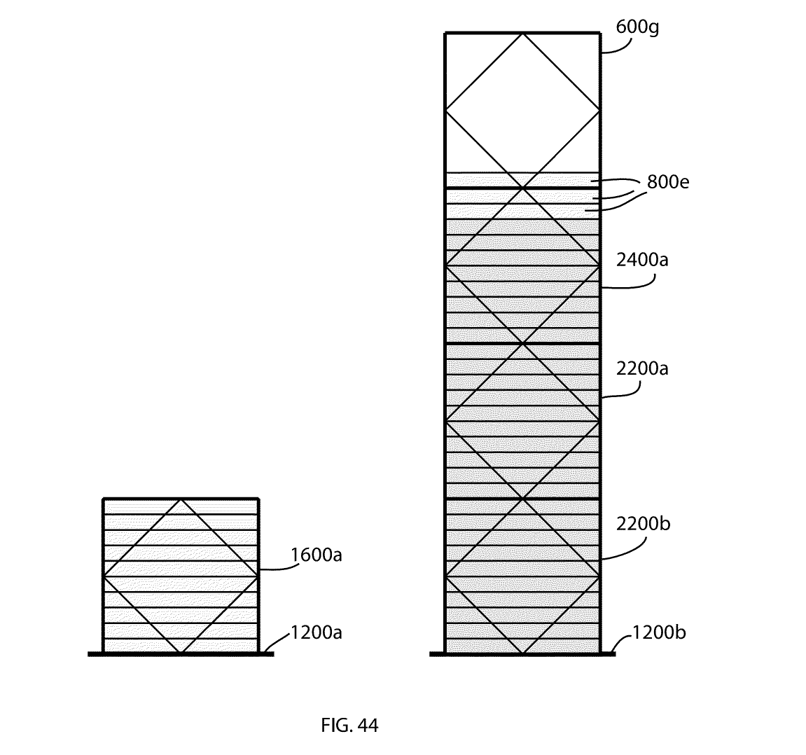

FIG. 44 illustrates the end result of the drag operation that was initiated in FIG. 40.

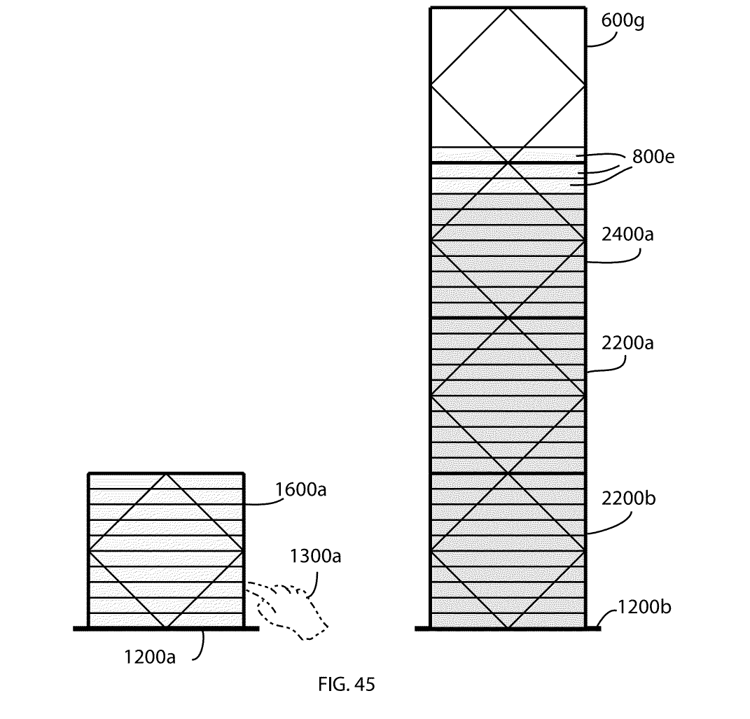

FIG. 45 illustrates the start of a user initiated drag of mvCrate 1600a, to transfer it from the left pile of crates to the right pile of crates.

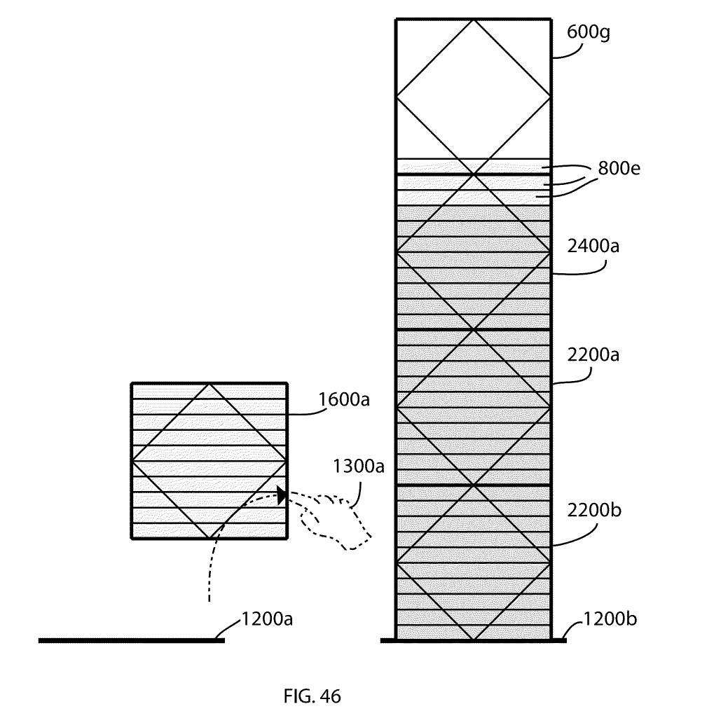

FIG. 46 illustrates the drag operation that was initiated in FIG. 45, while being in progress.

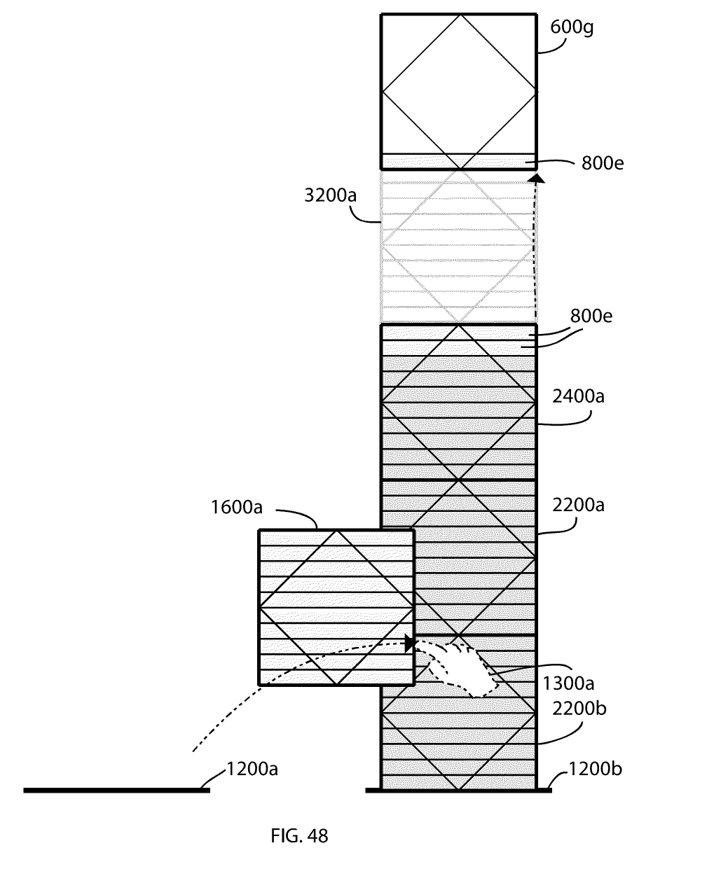

FIG. 48 illustrates the drag operation that was initiated in FIG. 45, while being in progress, whereby mvCrate 1600a has reached the right pile, causing mvCrate 600g to move up to create space for the insertion of mvCrate 1600a.

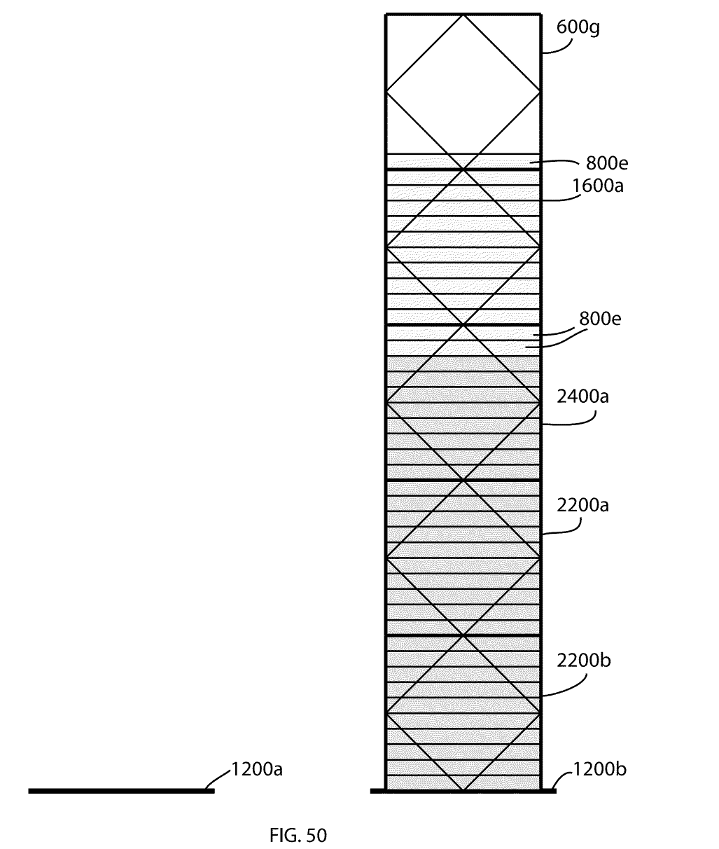

FIG. 50 illustrates the end result of the drag operation that was initiated in FIG. 45.

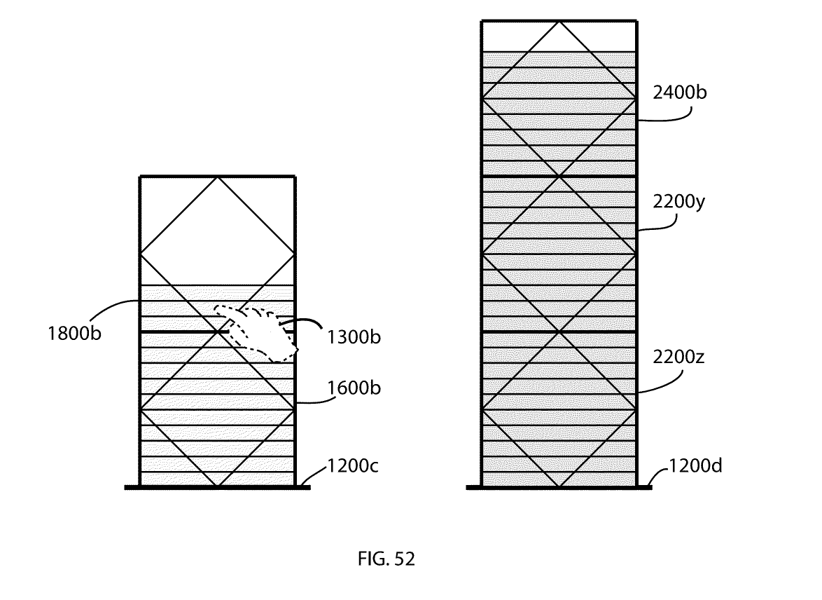

FIG. 52 illustrates the start of a user initiated drag of some mvBarTenths from mvCrate 1800b, to transfer it from the left pile of crates to the right pile of crates.

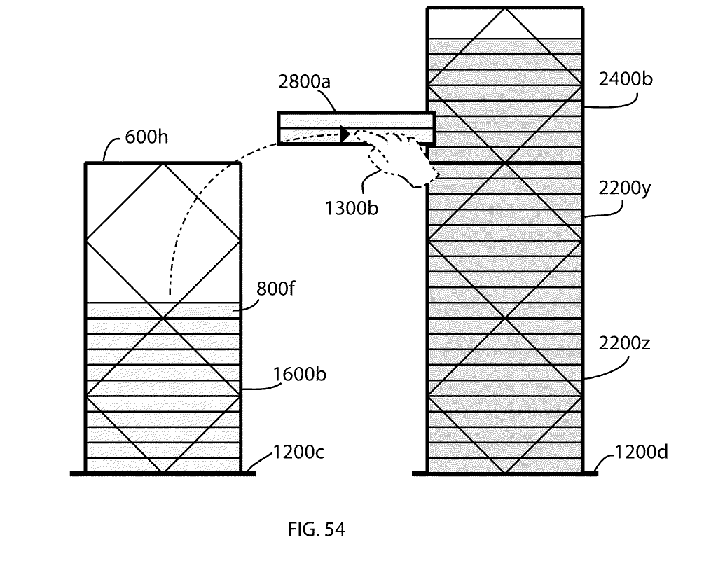

FIG. 54 illustrates the drag operation that was initiated in FIG. 52, while being in progress.

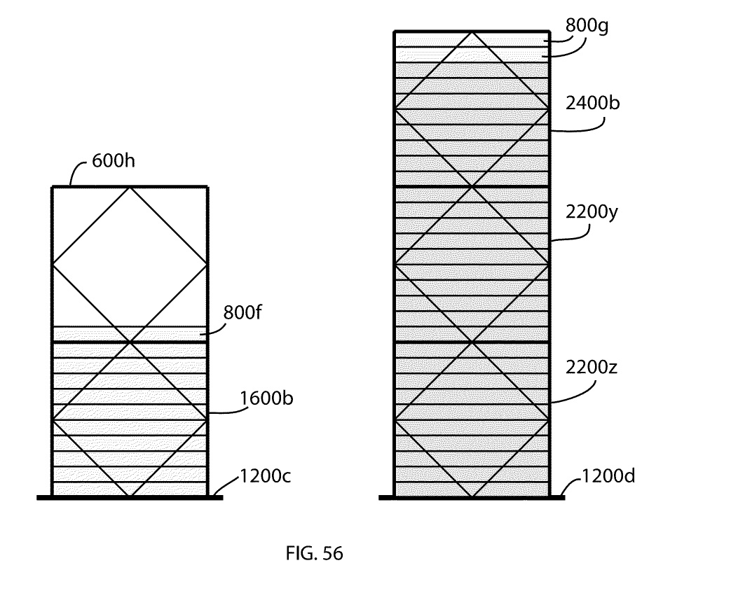

FIG. 56 illustrates the end result of the drag operation that was initiated in FIG. 52.

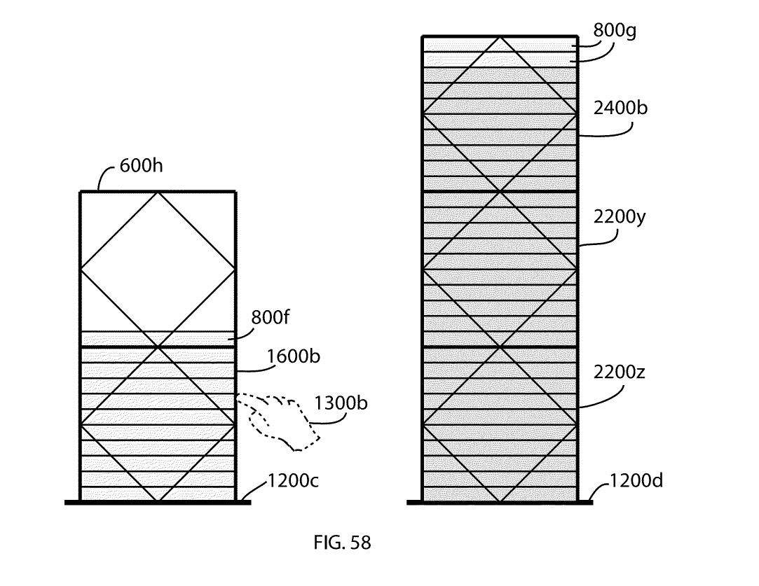

FIG. 58 illustrates the start of a user initiated drag of mvCrate 1600b, to transfer it from the left pile of crates to the right pile of crates.

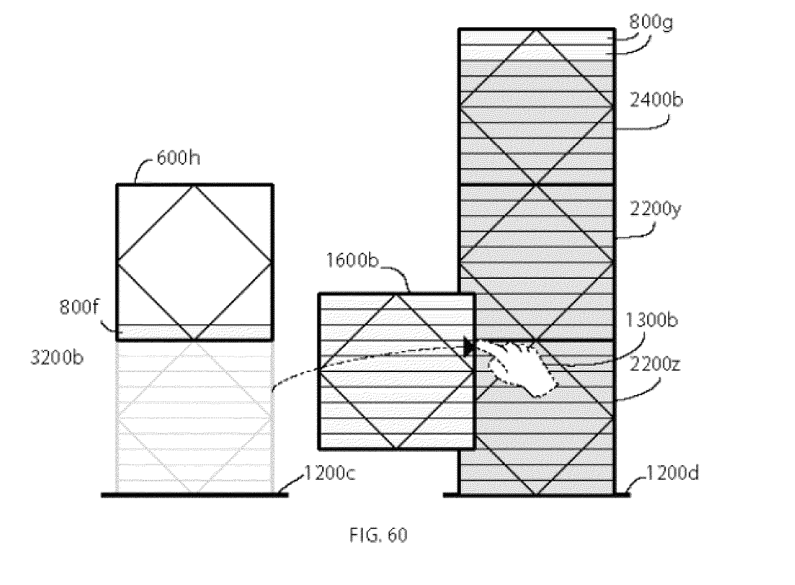

FIG. 60 illustrates the drag operation that was initiated in FIG. 58, while being in progress.

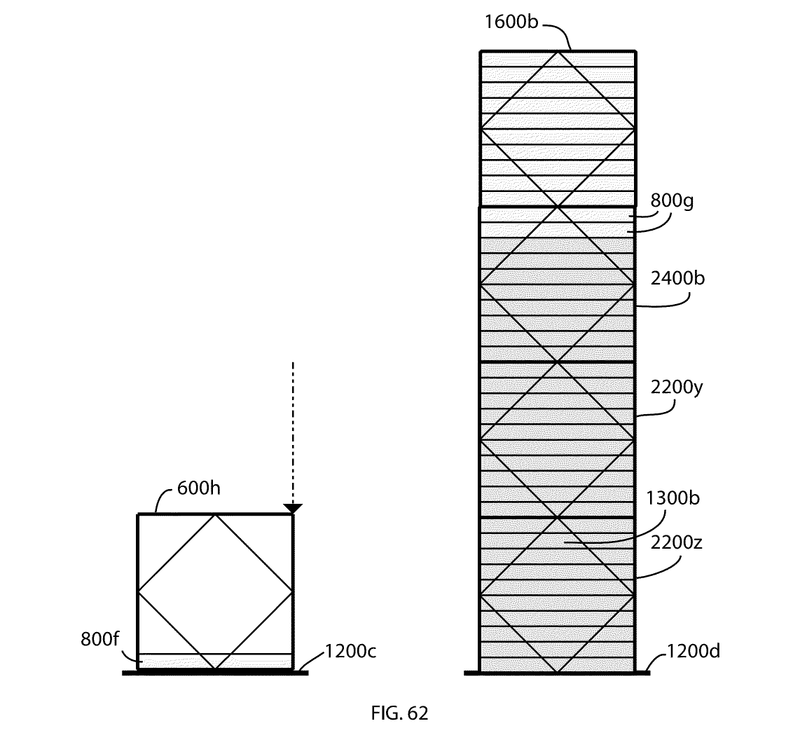

FIG. 62 illustrates the end result of the drag operation that was initiated in FIG. 58.

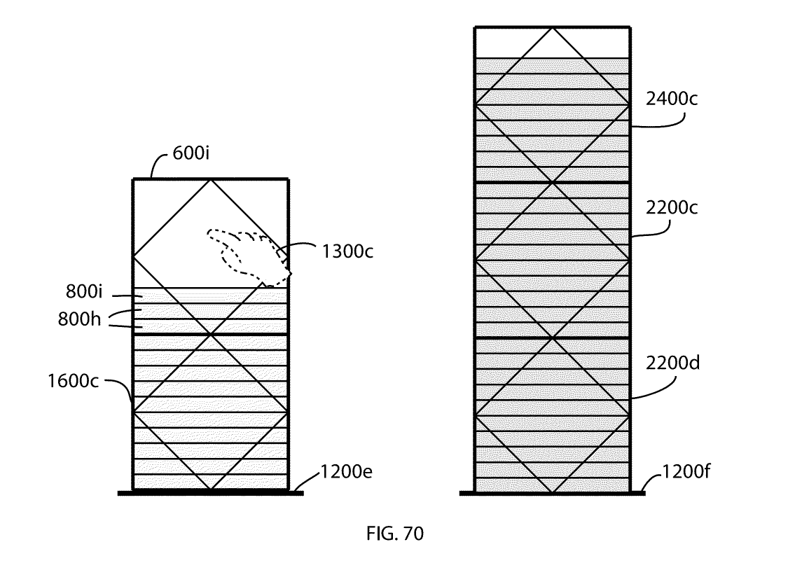

FIG. 70 illustrates the start of a user initiated drag of mvBarTenth 800i, to transfer it from the left pile of crates to the right pile of crates.

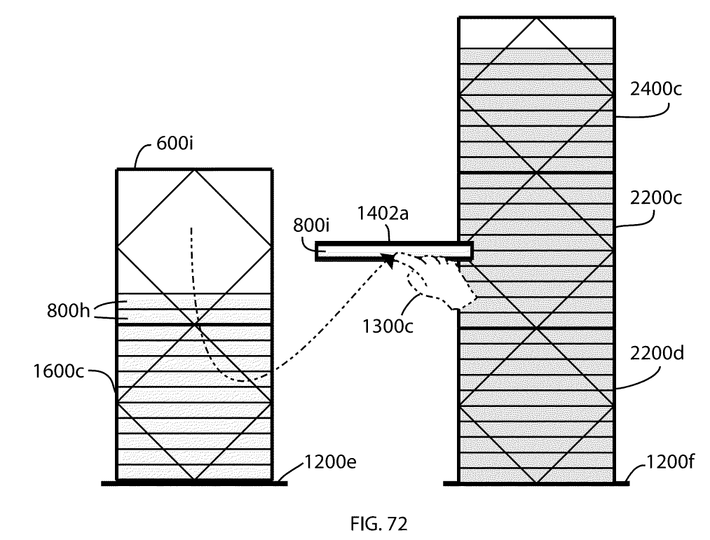

FIG. 72 illustrates the drag operation that was initiated in FIG. 70, while being in progress.

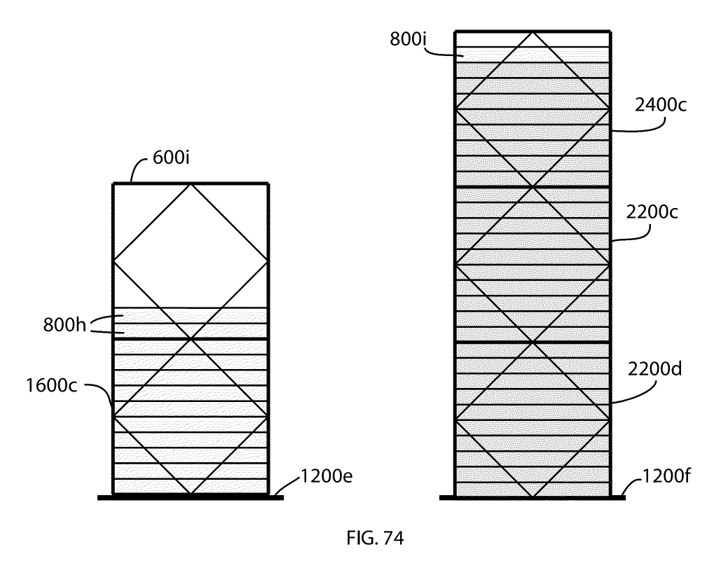

FIG. 74 illustrates the end result of the drag operation that was initiated in FIG. 70.

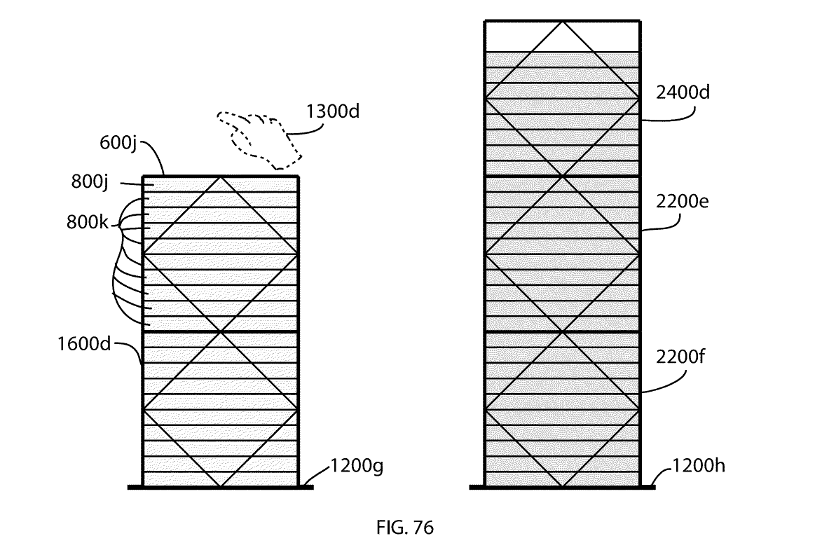

FIG. 76 illustrates the start of a user initiated drag of mvBarTenth 800j, to transfer it from the left pile of crates to the right pile of crates.

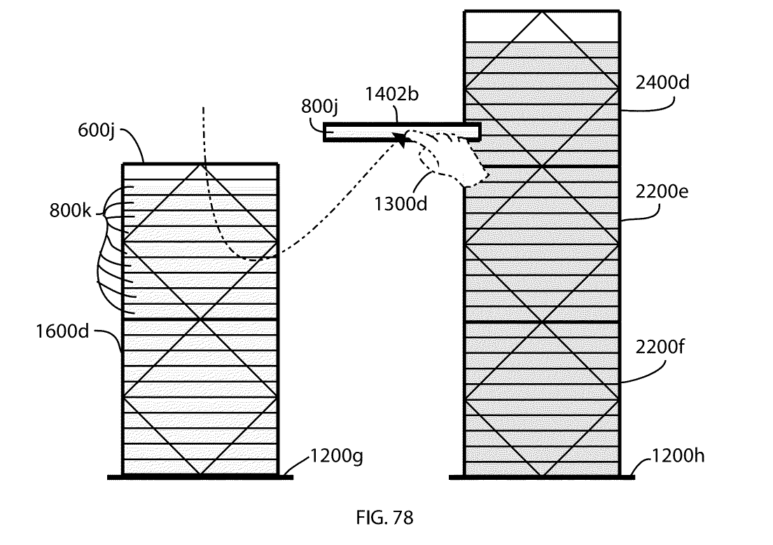

FIG. 78 illustrates the drag operation that was initiated in FIG. 76, while being in progress.

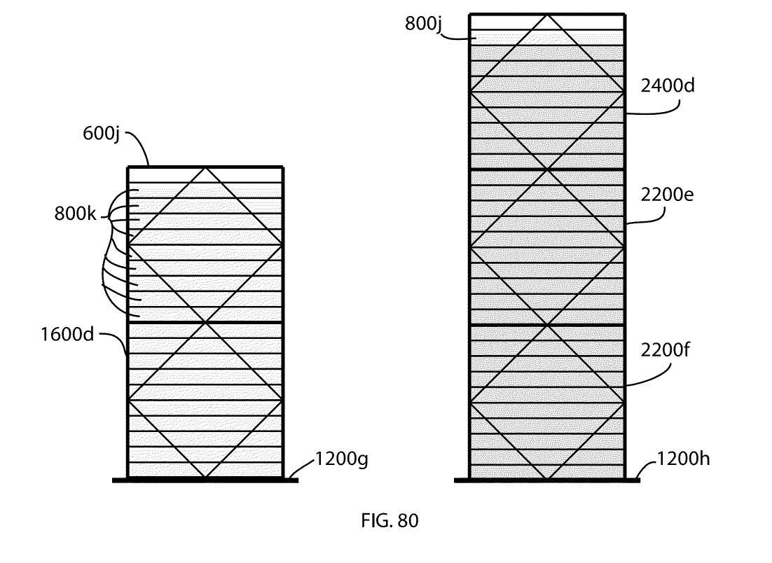

FIG. 80 illustrates the end result of the drag operation that was initiated in FIG. 76.

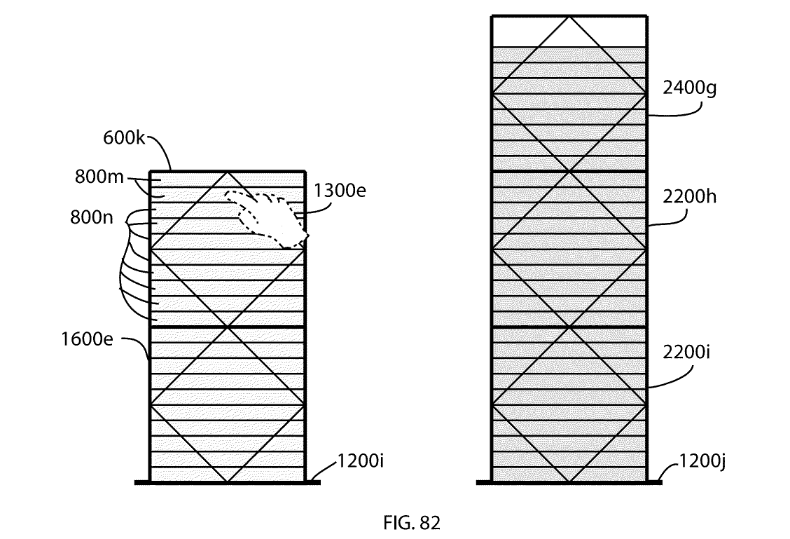

FIG. 82 illustrates the start of a user initiated drag of two mvBarTenths 800m, to transfer them from the left pile of crates to the right pile of crates.

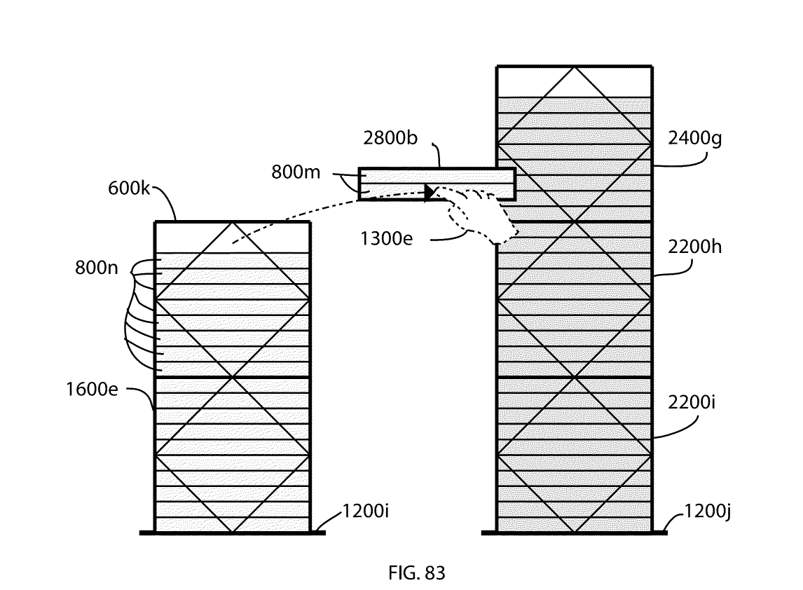

FIG. 83 illustrates the drag operation that was initiated in FIG. 82, while being in progress.

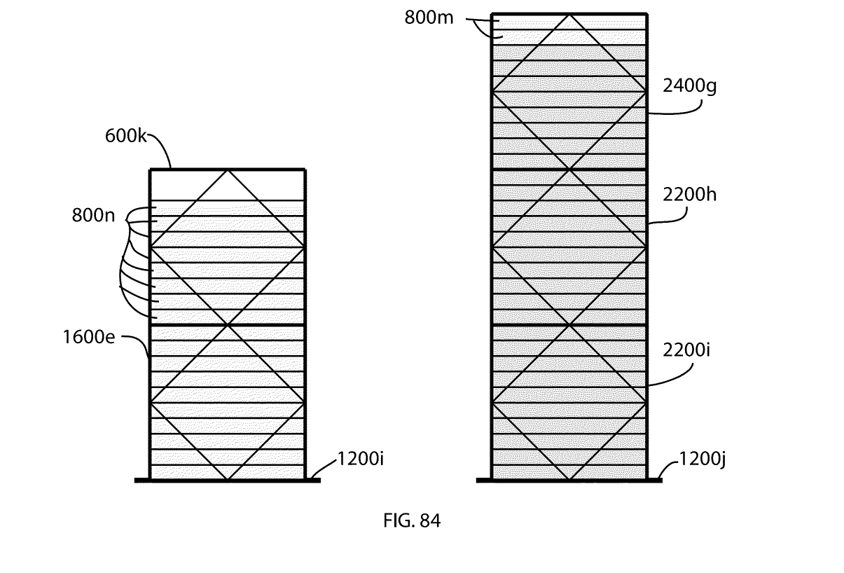

FIG. 84 illustrates the end result of the drag operation that was initiated in FIG. 82.

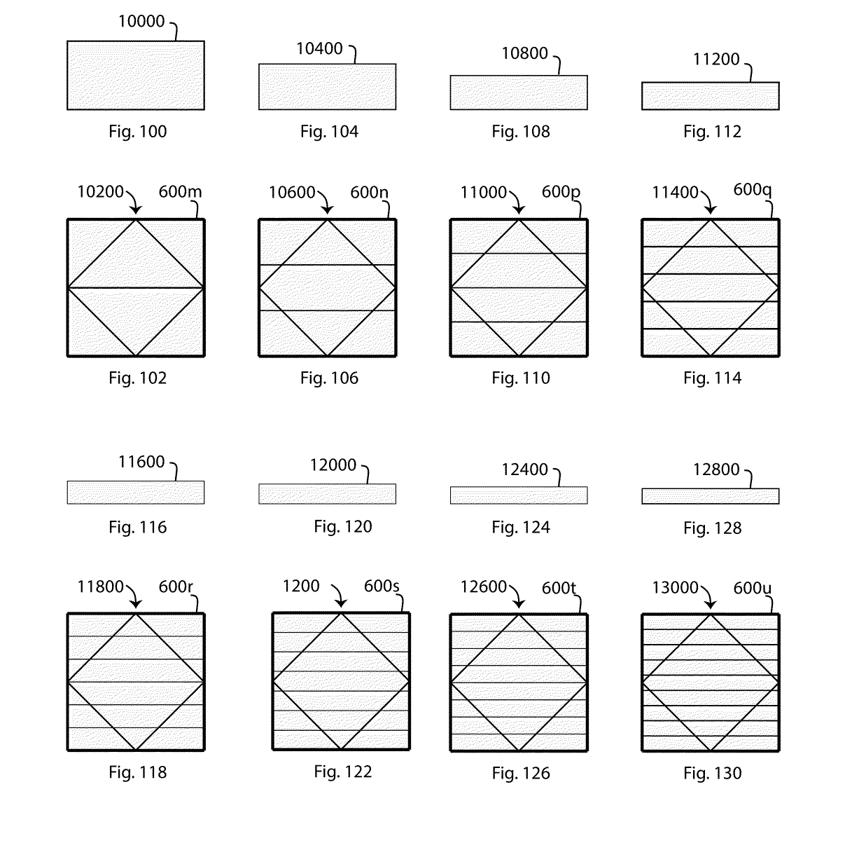

FIG. 100 shows an mvBarHalf 10000.

FIG. 102 shows an mvCrate 600m, filled with mvBarHalf 10000 elements.

FIG. 104 shows an mvBarThird 10400.

FIG. 106 shows an mvCrate 600n, filled with mvBarThird 10400 elements.

FIG. 108 shows an mvBarFourth 10800.

FIG. 110 shows an mvCrate 600p, filled with mvBarFourth 10800 elements.

FIG. 112 shows an mvBarFifth 11200.

FIG. 114 shows an mvCrate 600q, filled with mvBarFifth 11200 elements.

FIG. 116 shows an mvBarSixth 11600.

FIG. 118 shows an mvCrate 600r, filled with mvBarSixth 11600 elements.

FIG. 120 shows an mvBarSeventh 12000.

FIG. 122 shows an mvCrate 600s, filled with mvBarSixth 12000 elements.

FIG. 124 shows an mvBarEighth 12400.

FIG. 126 shows an mvCrate 600t, filled with mvBarEighth 12400 elements.

FIG. 128 shows an mvBarNinth 12800.

FIG. 130 shows an mvCrate 600u, filled with mvBarNinth 13000 elements.

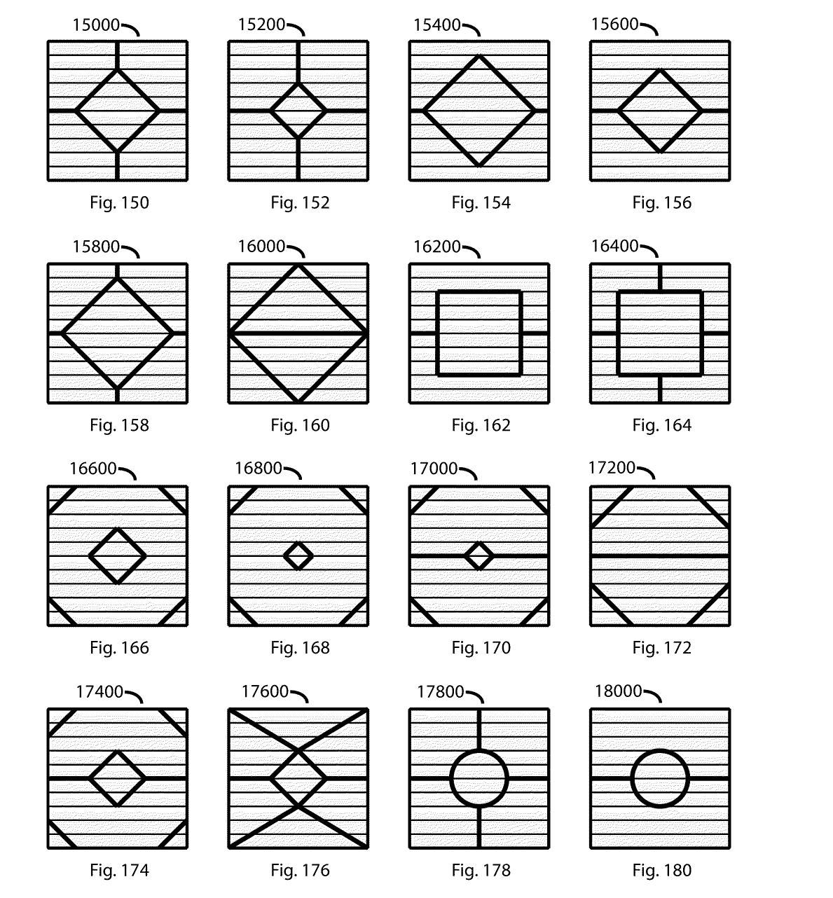

FIGS. 150, 152, 154, 156, 158, 160, 162, 164, 166, 168, 170, 172, 174, 176, 178 and 180 each show a crate filled with ten bars. Each of the figures demonstrate an alternative, useful type of count helper shape.

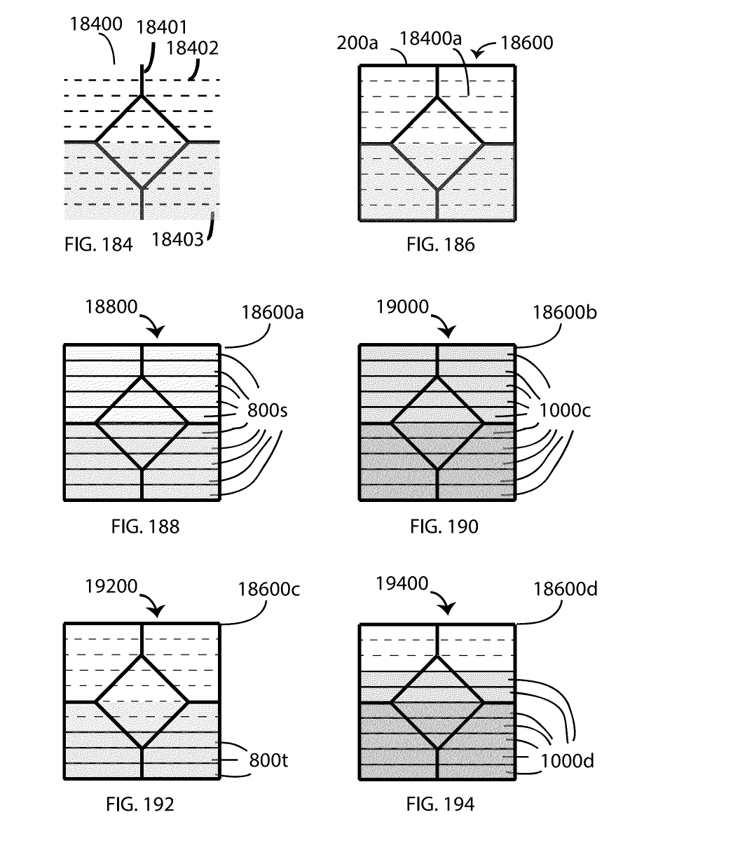

FIGS. 184, 186, 188, 190, 192 and 194 illustrate the use of an another example of a count helper.

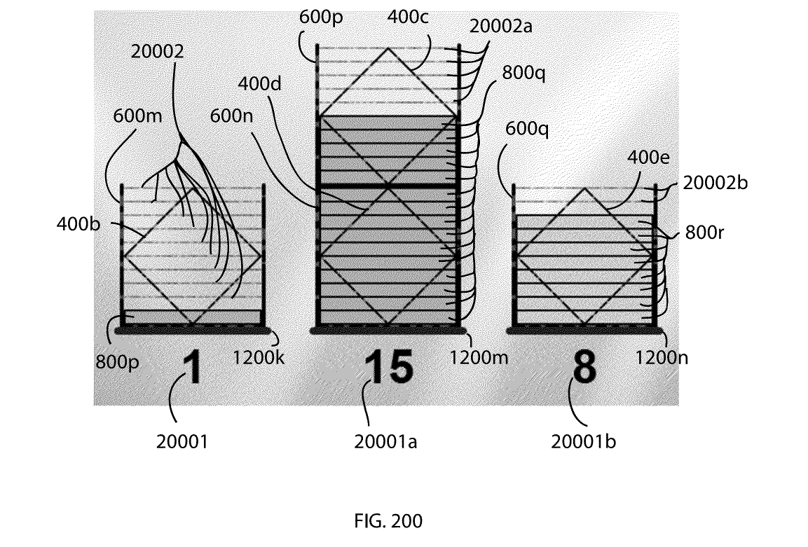

FIG. 200 illustrates an example of an additional embodiment of three piles of mvCrates, for which the lines that are used to represent the mvCrateDelimiters 600m, 600n, 600p and 600q and the mvCountHelpers 400b, 400c, 400d and 400e comprise lines that alternate between two colors in a randomized manner. mvBarGuideLineTenths 20002, 20002a and 20002b have been added to mvCrate 600m, 600p and 600q, respectively. Below the piles, there are mvNumberDisplays 20001, 20001a and 20001b.

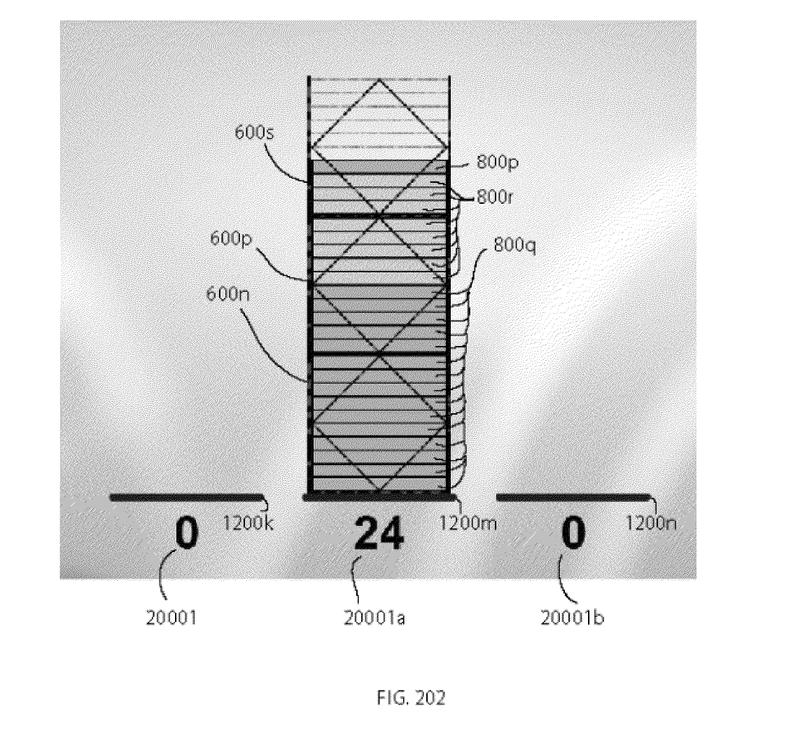

FIG. 202 illustrates the result of an example wherein starting from the state that is illustrated in FIG. 200, the user initiated transfers have caused the mvBarTenths 800r and 800p (in that order) from the mvCrates from the third and first pile to be stacked upon the mvBarTenths 800q of the second pile.

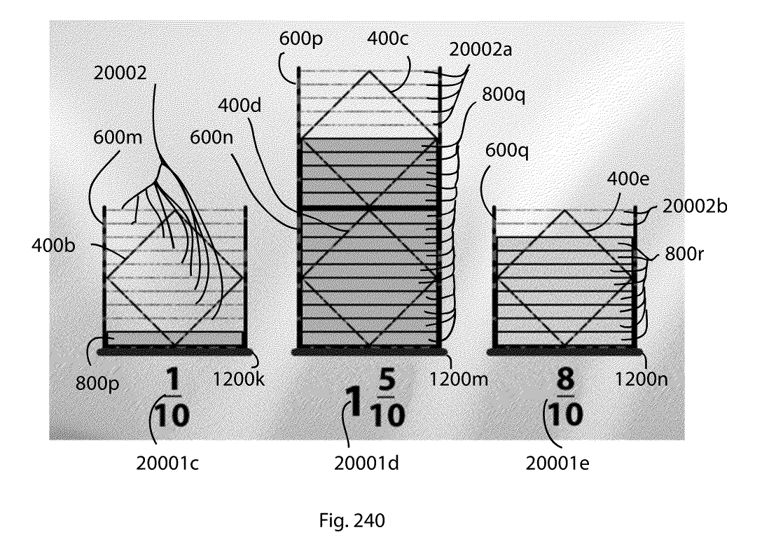

FIG. 240 illustrates an example of an additional embodiment that is identical to the embodiment of FIG. 200, except for the values that are displayed in the mvNumberDisplays, which show fractional values here, rather than integer values.

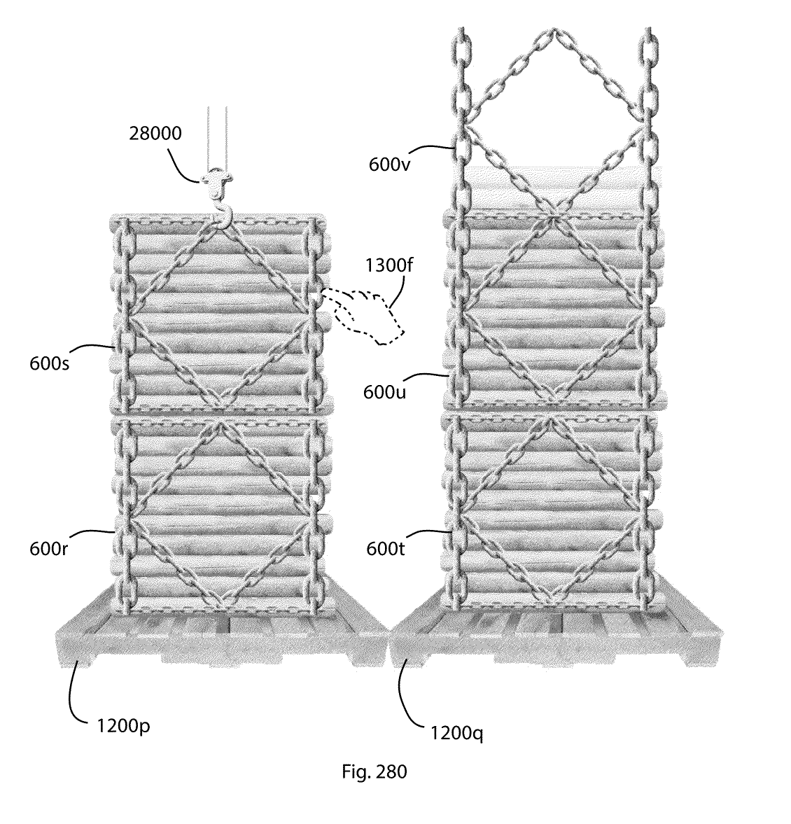

FIG. 280 illustrates an example of an alternative embodiment comprising a wood industry theme.

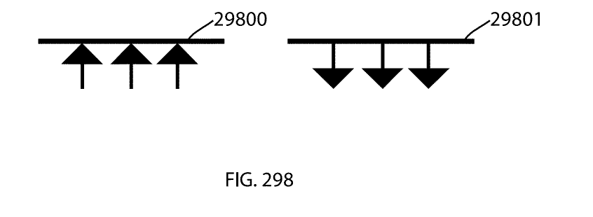

FIG. 298 illustrates examples of mvReservoirLocation 29800 and mvTrashLocation 29801.

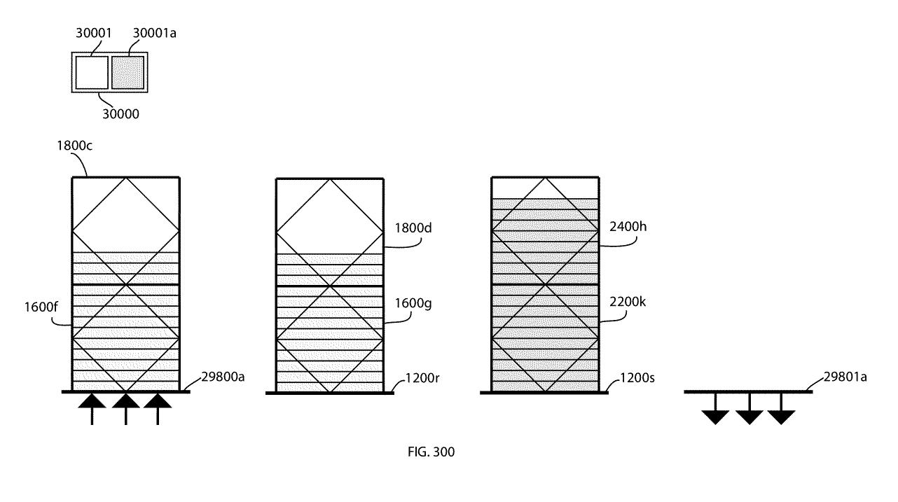

FIG. 300 illustrates an example of one embodiment that can be used to set up a set of piles.

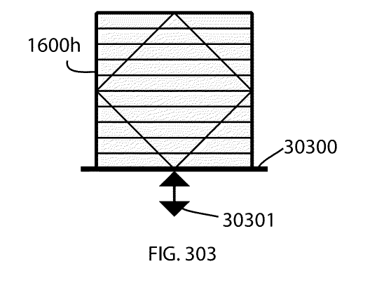

FIG. 303 illustrates an example of mvStoreAndRetrieveLocation 30300 with mvStoreAndRetrieveSymbol 30301 attached to it.

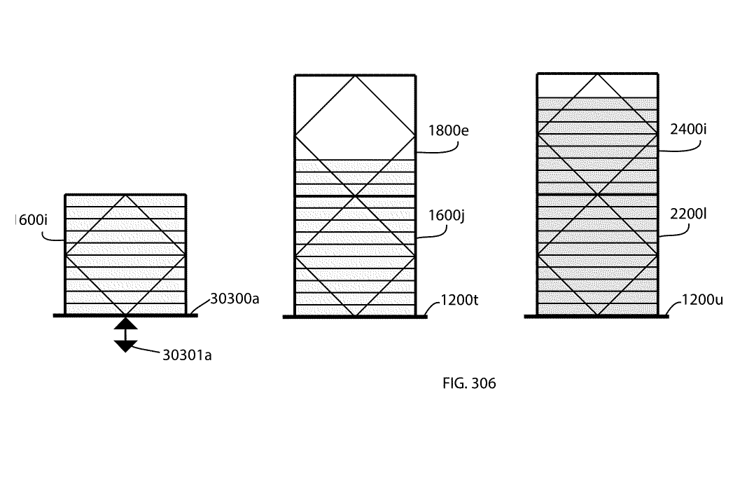

FIG. 306 illustrates an example of a embodiment that can be used to set up a set of piles.

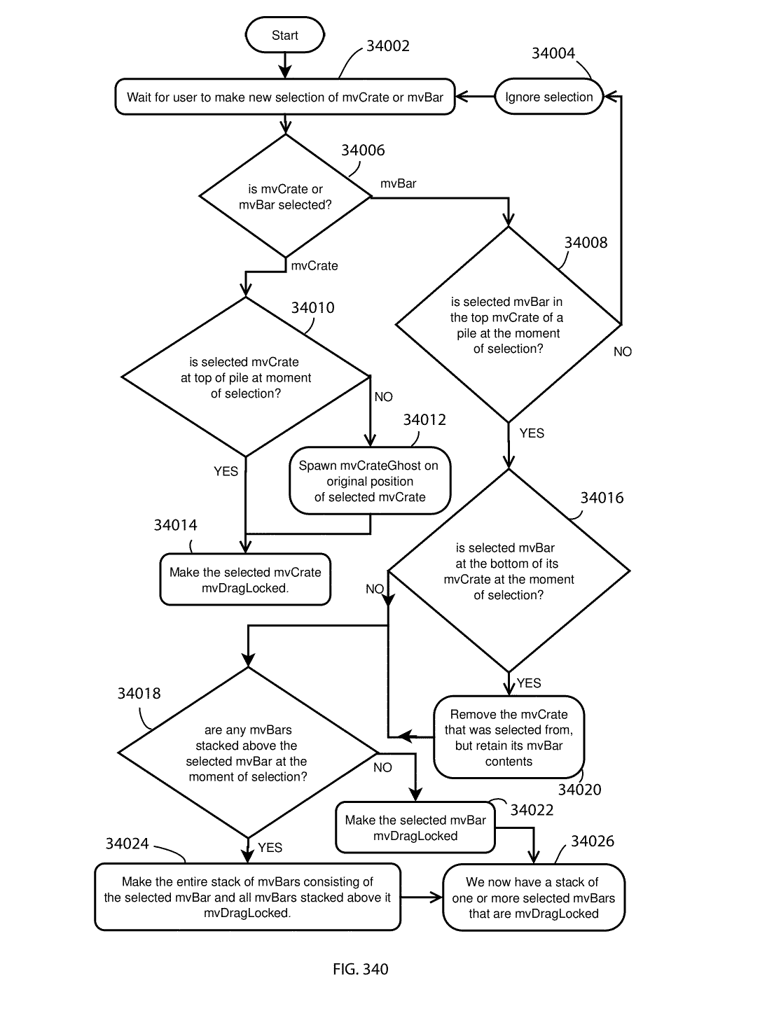

FIG. 340 illustrates a process for providing support for transfer initiation as part of the pile manipulation according to one embodiment of the present invention.

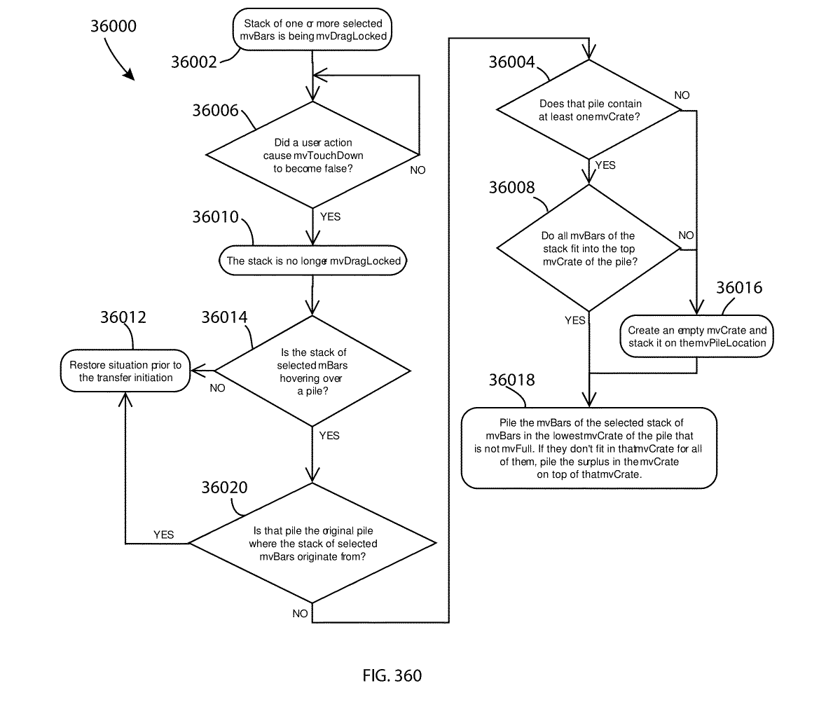

FIG. 360 illustrates a process for providing support for transfer finalization for a stack of one or more selected mvBars as part of the pile manipulation according to one embodiment of the present invention.

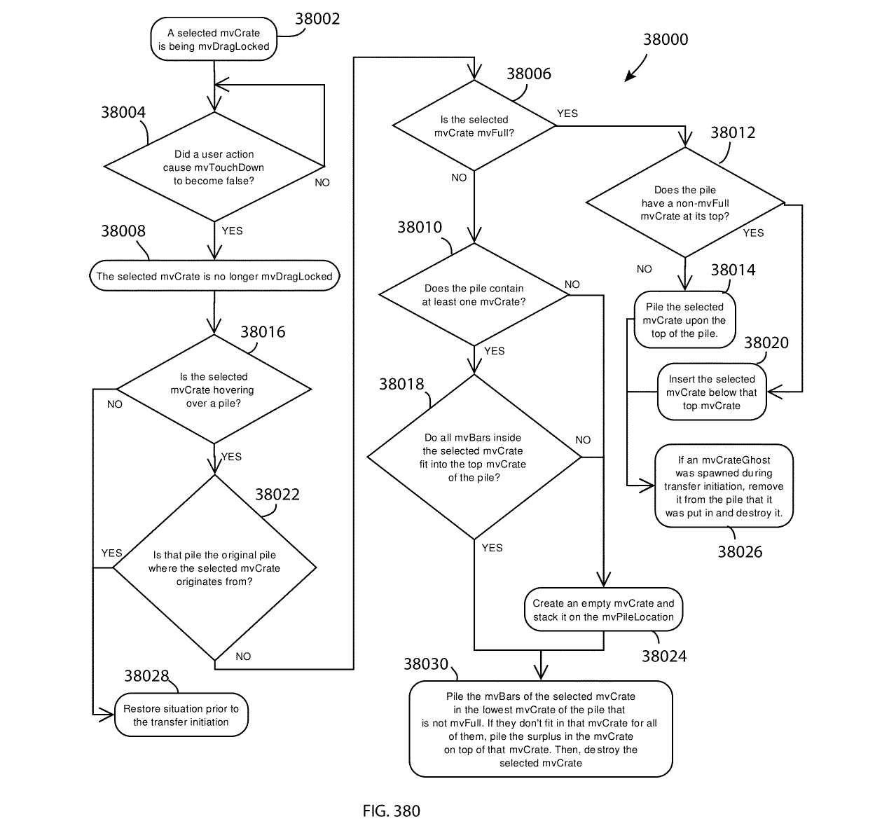

FIG. 380 illustrates a process for providing support for transfer finalization for a selected mvCrate as part of the pile manipulation according to one embodiment of the present invention.

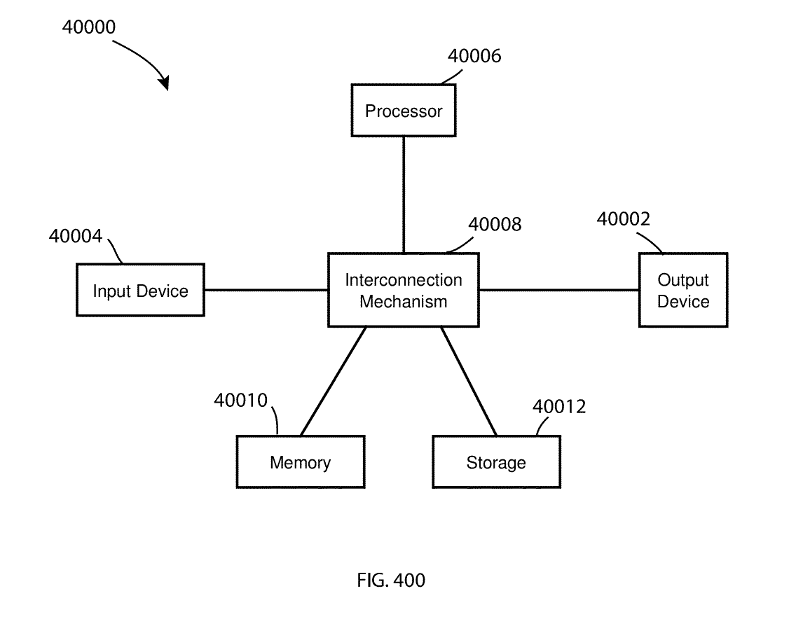

FIG. 400 is a block diagram of a system for providing pile manipulation functionality according to one embodiment of the present invention.

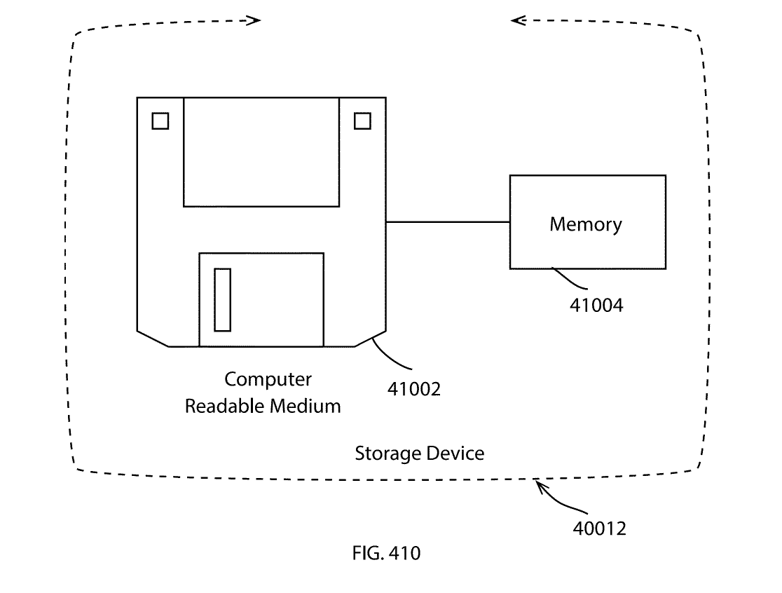

FIG. 410 is a block diagram of a system for providing pile manipulation functionality according to one embodiment of the invention.

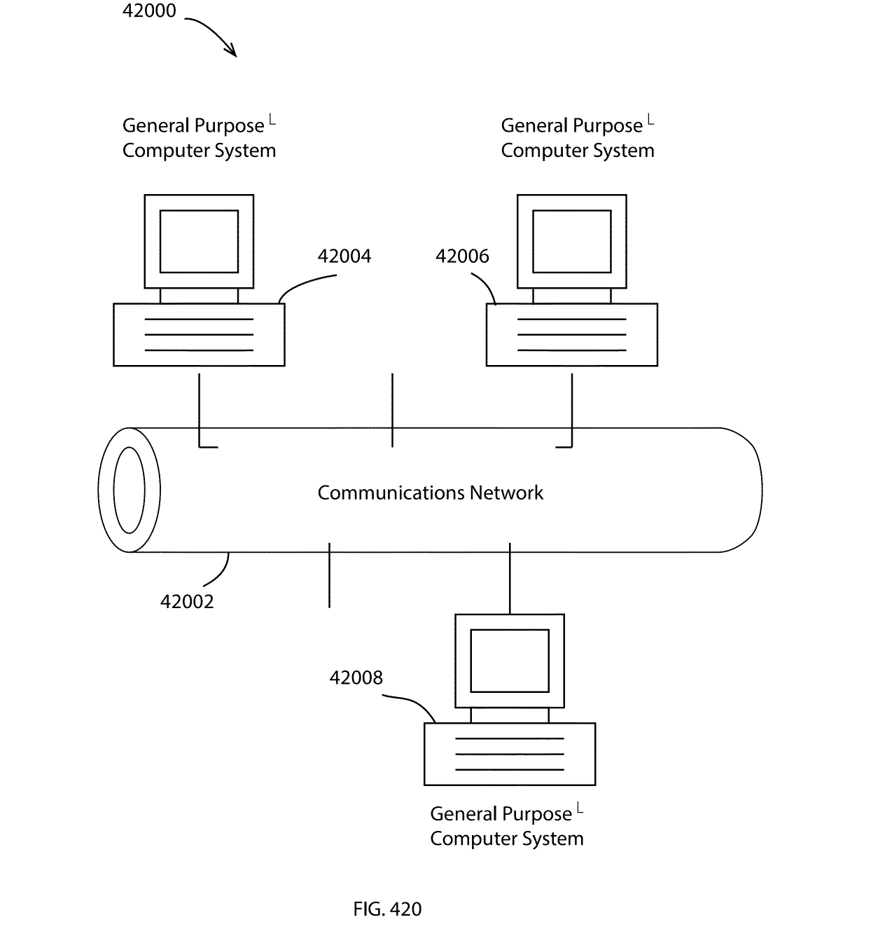

FIG. 420 is a block diagram of a system for providing pile manipulation functionality according to one embodiment of the invention.

DRAWINGS - REFERENCE NUMERALS

| 200 | mvCrateDelimiter | 400 | mvCountHelper |
|---|---|---|---|
| 600 | mvCrate | 800 | light color mvBarTenth |
| 1000 | dark color mvBarTenth | 1200 | mvPileLocation |
| 1300 | mvHandPointer | 1400 | mvPackageDelimiter of size two |
| 1402 | mvPackageDelimiter of size one | | |
| 1600 | light color mvFull mvCrate | 1800 | partially filled light color mvCrate |
| 2200 | dark color mvFull mvCrate | 2400 | partially filled dark color mvCrate |
| 2800 | mvPackage of size two | 3200 | mvCrateGhost |
| 10000 | mvBarHalf | 10200 | mvCrate, filled with 2 mvBarHalfs |
| 10400 | mvBarThird | 10600 | mvCrate, filled with 3 mvBarThirds |
| 10800 | mvBarFourth | 11000 | mvCrate, filled with 4 mvBarFourths |
| 11200 | mvBarFifth | 11400 | mvCrate, filled with 5 mvBarFifths |
| 11600 | mvBarSixth | 11800 | mvCrate, filled with 6 mvBarSixths |
| 12000 | mvBarSeventh | 12200 | mvCrate, filled with 7 mvBarSevenths |
| 12400 | mvBarEighth | 12600 | mvCrate, filled with 8 mvBarEighths |
| 12800 | mvBarNinth | 13000 | mvCrate, filled with 9 mvBarNinths |

15000, 15200, 15400, 15600, 15800, 16000, 16200, 16400, 16600, 16800, 17000, 17200,
17400, 17600, 17800, 18000 mvFull mvCrates, each illustrating the use of a different
alternative of an mvCountHelper type.

| 20001 | mvNumberDisplay | 20002 | mvBarGuideLineTenths |
|---|---|---|---|
| 28000 | hook of a crane | 29800 | mvReservoirLocation |
| 29801 | mvTrashLocation | 30000 | mvBarStylePalette |
| 30001 | mvBarStylePaletteEntry | 30300 | mvStoreAndRetrieveLocation |
| 30301 | mvStoreAndRetrieveSymbol | 34002 | wait for selection |
| 34004 | ignore selection | 34006 | test mvCrate or mvBar selected |
| 34008 | test mvBar in top of mvCrate | 34010 | test mvCrate at top of pile |
| 34012 | spawn mvCrateGhost | 34014 | mvDragLock selected mvCrate |
| 34016 | test mvBar at bottom of mvCrate | 34018 | test mvBars above selected mvBar |
| 34020 | remove mvCrate selected from | 34022 | mvDragLock selected mvBar |
| 34024 | mvDragLock selected stack mvBars | 34026 | stack of mvDragLocked mvBars |
| 36000 | process to finalize transfer of stack of mvDragLocked mvBars | | |
| 36002 | stack of mvDragLocked mvBars | 36004 | test pile contains mvCrate |
| 36006 | test mvTouchDown became false | 36008 | test mvbars fit into top mvCrate |
| 36010 | stack is no longer mvDragLocked | 36012 | restore to prior to transfer initiation |
| 36014 | test mvBars hovering over pile | 36016 | stack new empty mvCrate |
| 36018 | pile mvBars on pile | 36020 | test pile equals originating pile |
| 38000 | process to finalize transfer of mvDragLocked mvCrate | | |
| 38002 | mvDragLocked mvCrate | 38004 | test mvTouchDown became false |
| 38006 | test is selected mvCrate mvFull | 38008 | mvCrate is no longer mvDragLocked |
| 38010 | test pile contains mvCrate | 38012 | test pile has non-mvFull mvCrate at top |
| 38014 | pile selected mvCrate on top | 38016 | test selected mvCrate over pile |
| 38018 | test mvBars fit into top mvCrate | 38020 | insert selected mvCrate below top one |
| 38022 | test pile is originating pile | 38024 | stack new mvCrate on mvPileLocation |
| 38026 | remove any mvCrateGhost | 38028 | restore to prior transfer initiation |
| 38030 | pile mvBars on pile | 40000 | block diagram |
| 40002 | output device | 40004 | input device |
| 40006 | processor | 40008 | interconnection mechanism |
| 40010 | memory | 40012 | storage |
| 41002 | computer readable medium | 41004 | memory |
| 42000 | distributed system | 42002 | communications network |

42004, 42006, 42008 general purpose computer systems

### GLOSSARY

Part of the technical definitions that are introduced in this document detailed description involve concepts or actions rather than displayable objects, which thus have not been assigned reference numerals. The glossary below provides a central place that facilitates lookup of these definitions.

mvTouchDown The mvTouchDown state is a boolean state, that can have the value true or false. In the case that a touch screen is used as input device, mvTouchDown is true while a finger is being pressed against that touch screen, and false otherwise. In the case that a mouse is used as input device, mvTouchDown is true while a predetermined mousebutton is being held pressed, and false otherwise.

mvTouchLocation The mvTouchLocation is a two-coordinate (x,y) location value, which reflects a location on the electronic display while mvTouchDown equals true. If mvTouchDown is false, its value is unused and thus redundant. In the case that a touch screen is used as input device, mvTouchLocation represents the current location where a finger is currently being pressed against that touch screen. In the case that a mouse is used as input device, mvTouchLocation represents the location of the mouse pointer while the predetermined mouse button is being held pressed that causes mvTouchDown to be equal to true.

mvDraggingPath An mvDraggingPath is a path that is defined by the user changing the mvTouchLocation while mvTouchDown equals true. In all figures where a phantom arrow trails the mvHandPointer, that phantom arrow defines an mvDraggingPath.

mvDragLocked An element is said to be mvDragLocked when the difference between the mvTouchLocation and the momentary location of that element is frozen. The element thus moves along with the mvTouchLocation in a synchrone manner if it is mvDragLocked.

mvDragged An element is said to be mvDragged if that element is in an mvDragLocked state and is moved as a result of movement of mvTouchLocation.

mvBar An mvBar is an approximately rectangular shaped graphical object.

mvFull An mvCrate (See FIG. 6) is said to be mvFull if that mvCrate holds the maximum amount of a predetermined type of mvBars (examples: FIGS. 8, 100, 104) that it can hold.

### DETAILED DESCRIPTION

### FIGS Below 100

### The First Embodiment

FIG. 2 shows an mvCrateDelimiter 200. An mvCrateDelimiter is a graphical representation of a delimiter/container that can hold an integer number of mvBars (See descriptions of FIG. 8 and FIG. 10). An mvBar is an approximately rectangular (shaped graphical-) object.

FIG. 4 shows an mvCountHelper 400. An mvCountHelper is a count helper, a graphical shape that is used to facilitate counting of any mvBars that are confined inside an mvCrateDelimiter.

FIG. 6 shows an mvCrate 600. An mvCrate comprises an mvCrateDelimiter 200a, such that it can hold mvBars. Furthermore, it comprises an mvCountHelper 400a, which overlays any mvBars within the mvCrateDelimiter.

FIG. 8 shows a specific mvBarTenth 800 which has a light color. An mvBarTenth is an mvBar of which an amount of 10 can be stacked, approximately filling up an mvCrate (as is shown in FIG. 16).

FIG. 10 shows a specific mvBarTenth 1000 with a dark color. By the use of different colors, it is illustrated that collections of mvBars can be given somewhat different graphical representations to help clarifying an educational goal.

FIG. 12 shows an mvPileLocation 1200. An mvPileLocation is a pile location indicator: a graphical representation of a location on top of which one or more mvCrates can be piled.

FIG. 13 shows an mvHandPointer. The mvHandPointer is included for the purpose of indicating the current position of mouse pointer or touch location, for the case that a touchscreen is used. It facilitates the discussions in this document. The mvHandPointer need not be displayed on the display device.

FIG. 14 shows a specific mvPackageDelimiter 1400 of size two, as well as a specific mvPackageDelimiter 1402 of size one. An mvPackageDelimiter is a graphical representation of a delimiter/container that is used to hold a predetermined amount stacked mvBars. Within mvPackageDelimiter 1400, approximately two stacked mvBars fit in, which is why it is called an mvPackageDelimiter of size 2. In a similar way, mvPackageDelimiters for different sizes are hereby defined. A difference between an mvCrateDelimiter and an mvPackageDelimiter is that the mvCrateDelimiter does not need to be filled with the maximum amount of mvBars that it can hold, while an mvPackageDelimiter always is. Typically mvPackageDelimiters are used to identify the grouping of collections of mvBars that are being dragged out of mvCrates.

FIG. 16 shows a specific mvCrate 1600, which is mvFull, and comprises mvCrate 600a, containing only mvBarTenths with light color 800a. An mvCrate is said to be mvFull if that mvCrate holds the maximum amount of a predetermined type of mvBars (examples: FIGS. 8, 100, 104) that it can hold.

FIG. 18 shows a specific mvCrate 1800, which comprises mvCrate 600b, containing three mvBarTenths of light color 800b.

FIG. 22 shows a specific mvCrate 2200, which is mvFull, and comprises mvCrate 600d, containing only mvBarTenths with dark color 1000a.

FIG. 24 shows a specific mvCrate 2400, which comprises mvCrate 600e, containing eight mvBarTenths of dark color 1000b.

FIG. 28 shows a specific mvPackage 2800 of size two. This mvPackage comprises a stack of two mvBars 800b that is delimited by an mvPackageDelimiter 14000e. In a similar way, mvPackages of size N that consist of N mvBars that are delimited by an mvPackageDelimiter of size N are hereby defined.

FIG. 32 shows a specific mvCrateGhost 3200. An mvCrateGhost is an mvFull mvCrate, being made transparent and/or being color transformed. In this specific case, it involves an mvCrate that is filled with mvBarTenths, while a color transformation is achieved by overlaying the mvCrate with a transparent white overlay color.

FIG. 40 shows a pile comprising mvCrate 1600a and mvCrate 1800a, stacked on mvPileLocation 1200a on the left. It shows another pile, comprising mvCrate 2200a, mvCrate 2200b and mvCrate 2400a, stacked on mvPileLocation 1200b on the right. An mvHandPointer 1300a indicates the location where a user initiated drag is being started.

FIG. 42 shows a pile comprising mvCrate 1600a stacked on mvPileLocation 1200a on the left. It shows another pile, comprising mvCrate 2200a, mvCrate 2200b and mvCrate 2400a, stacked on mvPileLocation 1200b on the right. Furthermore, it shows mvCrate 1800a in the process of being dragged by the user towards the pile on the right, indicated by mvHandPointer 1300a and the phantom arrow leading to it.

FIG. 44 shows a pile comprising mvCrate 1600a stacked on mvPileLocation 1200a on the left. It shows another pile, comprising mvCrate 2200a, mvCrate 2200b and mvCrate 2400a, and mvCrate 600g, stacked on mvPileLocation 1200b on the right. mvCrate 2400a has been made mvFull by adding two mvBarTenths 800e. mvCrate 600g contains a single mvBarTenths 800e.

FIG. 45 shows a pile comprising mvCrate 1600a stacked on mvPileLocation 1200a on the left. It shows another pile, comprising mvCrate 2200a, mvCrate 2200b and mvCrate 2400a, and mvCrate 600g, stacked on mvPileLocation 1200b on the right. mvCrate 2400a has been made mvFull by adding two mvBarTenths 800e. mvCrate 600g contains a single mvBarTenths 800e. An mvHandPointer 1300a indicates the location where a user initiated drag is being started.

FIG. 46 shows a pile comprising mvCrate 2200a, mvCrate 2200b and mvCrate 2400a, and mvCrate 600g, stacked on mvPileLocation 1200b on the right. mvCrate 2400a has been made mvFull by adding two mvBarTenths 800e. mvCrate 600g contains a single mvBarTenths 800e. On the left, there is mvPileLocation 1200a with nothing stacked on top of it. Furthermore, it shows mvCrate 1600a in the process of being dragged by the user towards the pile on the right, indicated by mvHandPointer 1300a and the phantom arrow leading to it.

FIG. 48 shows a pile comprising mvCrate 2200a, mvCrate 2200b and mvCrate 2400a, and mvCrate 600g, stacked on mvPileLocation 1200b on the right. mvCrate 2400a has been made mvFull by adding two mvBarTenths 800e. mvCrate 600g contains a single mvBarTenths 800e. On the left, there is mvPileLocation 1200a with nothing stacked on top of it. Furthermore, it shows mvCrate 1600a in the process of being dragged by the user approaches the pile on the right, indicated by mvHandPointer 1300a and the phantom arrow leading to it. As mvCrate 1600a thus approaches the pile on the right, the non-mvFull mvCrate 600g moves up to create space for the insertion of mvCrate 1600a. While mvTouchDown is still true, in that space, mvCrateGhost 32000a is displayed, which is a ghost copy of mvCrate 1600a.

FIG. 50 shows a pile comprising mvCrate 2200a, mvCrate 2200b, mvCrate 2400a, mvCrate 1600a and mvCrate 600g, stacked on mvPileLocation 1200b on the right. mvCrate 2400a has been made mvFull by adding two mvBarTenths 800e. mvCrate 600g contains a single mvBarTenths 800e. On the left, there is mvPileLocation 1200a with nothing stacked on top of it.

FIG. 52 shows a pile comprising mvCrate 1600b and mvCrate 1800b, stacked on mvPileLocation 1200c on the left. It shows another pile, comprising mvCrate 2200y, mvCrate 2200z and mvCrate 2400b, stacked on mvPileLocation 1200d on the right. An mvHandPointer 1300b indicates the location where a user initiated drag is being started.

FIG. 54 shows a pile comprising mvCrate 1600b and mvCrate 600h, stacked on mvPileLocation 1200c on the left. mvCrate 600h contains a single mvBarTenth 800f of light color. It shows another pile, comprising mvCrate 2200y, mvCrate 2200z and mvCrate 2400b, stacked on mvPileLocation 1200d on the right. Furthermore, it shows mvPackage 2800a in the process of being dragged by the user towards the pile on the right, indicated by mvHandPointer 1300b and the phantom arrow leading to it.

FIG. 56 shows a pile comprising mvCrate 1600b and mvCrate 600h, stacked on mvPileLocation 1200c on the left. mvCrate 600h contains a single mvBarTenth 800f of light color. It shows another pile, comprising mvCrate 2200y, mvCrate 2200z and mvCrate 2400b, stacked on mvPileLocation 1200d on the right. Two mvBarTenths 800g of light color have been added to the content of mvCrate 2400b

FIG. 58 shows a pile comprising mvCrate 1600b and mvCrate 600h, stacked on mvPileLocation 1200c on the left. mvCrate 600h contains a single mvBarTenth 800f of light color. It shows another pile, comprising mvCrate 2200y, mvCrate 2200z and mvCrate 2400b, stacked on mvPileLocation 1200d on the right. Two mvBarTenths 800g of light color have been added to the content of mvCrate 2400b. An mvHandPointer 1300b indicates the location where a user initiated drag is being started.

FIG. 60 shows a pile comprising mvCrateGhost 3200b and mvCrate 600h, stacked on mvPileLocation 1200c on the left. mvCrate 600h contains a single mvBarTenth 800f of light color. It shows another pile, comprising mvCrate 2200y, mvCrate 2200z and mvCrate 2400b, stacked on mvPileLocation 1200d on the right. Two mvBarTenths 800g of light color have been added to the content of mvCrate 2400b. Furthermore, it shows mvCrate 1600b in the process of being dragged by the user towards the pile on the right, indicated by mvHandPointer 1300b and the phantom arrow leading to it.

FIG. 62 shows a pile comprising mvCrate 600h, stacked on mvPileLocation 1200c on the left. mvCrate 600h contains a single mvBarTenth 800f of light color. It shows another pile, comprising mvCrate 2200y, mvCrate 2200z, mvCrate 1600b and mvCrate 2400b, stacked on mvPileLocation 1200d on the right. Two mvBarTenths 800g of light color have been added to the content of mvCrate 2400b. A phantom arrow above the pile on the left indicates the move that mvCrate 600h made upon completion of the drag operation that involved the transfer of mvCrate 1600b.

FIG. 70 shows a pile comprising mvCrate 1600c and mvCrate 600i, stacked on mvPileLocation 1200e on the left. mvCrate 600i is filled by two mvBarTenths 800h and one mvBarTenth 800i. It shows another pile, comprising mvCrate 2200c, mvCrate 2200d and mvCrate 2400c, stacked on mvPileLocation 1200f on the right. An mvHandPointer 1300c indicates the location where a user initiated drag is being started.

FIG. 72 shows a pile comprising mvCrate 1600c and mvCrate 600i, stacked on mvPileLocation 1200e on the left. mvCrate 600i is filled by two mvBarTenths 800h. It shows another pile, comprising mvCrate 2200c, mvCrate 2200d and mvCrate 2400c, stacked on mvPileLocation 1200f on the right. Furthermore, it shows mvBarTenth 800i, delimited by mvPackageDelimiter 1402a in the process of being dragged by the user towards the pile on the right, indicated by mvHandPointer 1300c and the phantom arrow leading to it.

FIG. 74 shows a pile comprising mvCrate 1600c and mvCrate 600i, stacked on mvPileLocation 1200e on the left. mvCrate 600i is filled by two mvBarTenths 800h. It shows another pile, comprising mvCrate 2200c, mvCrate 2200d and mvCrate 2400c, stacked on mvPileLocation 1200f on the right. An additional mvBarTenth 800i has been added to the content of mvCrate 2400c.

FIG. 76 shows a pile comprising mvCrate 1600d and mvCrate 600j, stacked on mvPileLocation 1200g on the left. mvCrate 600j is mvFull. It is filled by nine mvBarTenths 800k and one mvBarTenth 800j. It shows another pile, comprising mvCrate 2200e, mvCrate 2200e and mvCrate 2400d, stacked on mvPileLocation 1200h on the right. An mvHandPointer 1300d indicates the location where a user initiated drag is being started.

FIG. 78 shows a pile comprising mvCrate 1600d and mvCrate 600j, stacked on mvPileLocation 1200g on the left. mvCrate 600j is filled by nine mvBarTenths 800k. It shows another pile, comprising mvCrate 2200e, mvCrate 2200e and mvCrate 2400d, stacked on mvPileLocation 1200h on the right. Furthermore, it shows mvBarTenth 800j, delimited by mvPackageDelimiter 1402b in the process of being dragged by the user towards the pile on the right, indicated by mvHandPointer 1300d and the phantom arrow leading to it.

FIG. 80 shows a pile comprising mvCrate 1600d and mvCrate 600j, stacked on mvPileLocation 1200g on the left. mvCrate 600j is filled by nine mvBarTenths 800k. It shows another pile, comprising mvCrate 2200e, mvCrate 2200e and mvCrate 2400d, stacked on mvPileLocation 1200h on the right. To the content of mvCrate 2400d, a single mvBarTenth 800j as been added.

FIG. 82 shows a pile comprising mvCrate 1600e and mvCrate 600k, stacked on mvPileLocation 1200i on the left. mvCrate 600k is mvFull. It is filled by eight mvBarTenths 800n and two mvBarTenths 800m. It shows another pile, comprising mvCrate 2200h, mvCrate 2200i and mvCrate 24000g, stacked on mvPileLocation 1200j on the right. An mvHandPointer 1300e indicates the location where a user initiated drag is being started.

FIG. 83 shows a pile comprising mvCrate 1600e and mvCrate 600k, stacked on mvPileLocation 1200i on the left. mvCrate 600k is filled by eight mvBarTenths 800n. It shows another pile, comprising mvCrate 2200h, mvCrate 2200i and mvCrate 24000g, stacked on mvPileLocation 1200j on the right. An mvHandPointer 1300e indicates the location where a user initiated drag is being started. Furthermore, it shows mvPackage 2800b, now containing mvBarTenths 800m in the process of being dragged by the user towards the pile on the right, indicated by mvHandPointer 1300e and the phantom arrow leading to it.

FIG. 84 shows a pile comprising mvCrate 1600e and mvCrate 600k, stacked on mvPileLocation 1200i on the left. mvCrate 600k is filled by eight mvBarTenths 800n. It shows another pile, comprising mvCrate 2200h, mvCrate 2200i and mvCrate 2400g, stacked on mvPileLocation 1200j on the right. The two mvBarTenths 800m have been added to mvCrate 2400g.

### FIGS. 100-130

### Examples of Aspects of Additional Embodiments that are Based on mvCrates that can Contain Predetermined Group Sizes of 2, 3, 4, 5, 6, 7, 8 and 9 mvBars

### FIGS. 100-102

### Example of an Aspect of an Additional Embodiment

FIG. 100 shows an mvBarHalf 10000. An mvBarHalf is an mvBar of which an amount of 2 can be stacked, approximately filling up an mvCrate (as is shown in FIG. 102).

FIG. 102 shows an mvCrate 600m which is mvFull, filled with mvBarHalf 10000 elements.

### FIGS. 104-106

### Example of an Aspect of an Additional Embodiment

FIG. 104 shows an mvBarThird 10400. An mvBarThird is an mvBar of which an amount of 3 can be stacked, approximately filling up an mvCrate (as is shown in FIG. 106).

FIG. 106 shows an mvCrate 600n which is mvFull, filled with mvBarThird 10400 elements.

### FIGS. 108-110

### Example of an Aspect of an Additional Embodiment

FIG. 108 shows an mvBarFourth 10800. An mvBarFourth is an mvBar of which an amount of 4 can be stacked, approximately filling up an mvCrate (as is shown in FIG. 110).

FIG. 110 shows an mvCrate 600p which is mvFull, filled with mvBarFourth 10800 elements.

### FIGS. 112-114

### Example of an Aspect of an Additional Embodiment

FIG. 112 shows an mvBarFifth 11200. An mvBarFifth is an mvBar of which an amount of 5 can be stacked, approximately filling up an mvCrate (as is shown in FIG. 114).

FIG. 114 shows an mvCrate 600q which is mvFull, filled with mvBarFifth 11200 elements.

### FIGS. 116-118

### Example of an Aspect of an Additional Embodiment

FIG. 116 shows an mvBarSixth 11600. An mvBarSixth is an mvBar of which an amount of 6 can be stacked, approximately filling up an mvCrate (as is shown in FIG. 118).

FIG. 118 shows an mvCrate 600r which is mvFull, filled with mvBarSixth 11600 elements.

### FIGS. 120-122

### Example of an Aspect of an Additional Embodiment

FIG. 120 shows an mvBarSeventh 12000. An mvBarSeventh is an mvBar of which an amount of 7 can be stacked, approximately filling up an mvCrate (as is shown in FIG. 122).

FIG. 122 shows an mvCrate 600s which is mvFull, filled with mvBarSixth 12000 elements.

### FIGS. 124-126

### Example of an Aspect of an Additional Embodiment

FIG. 124 shows an mvBarEighth 12400. An mvBarEighth is an mvBar of which an amount of 8 can be stacked, approximately filling up an mvCrate (as is shown in FIG. 126).

FIG. 126 shows an mvCrate 600t which is mvFull, filled with mvBarEighth 12400 elements.

### FIGS. 128-130

### Example of an Aspect of an Additional Embodiment

FIG. 128 shows an mvBarNinth 12800. An mvBarNinth is an mvBar of which an amount of 9 can be stacked, approximately filling up an mvCrate (as is shown in FIG. 130).

FIG. 130 shows an mvCrate 600u which is mvFull, filled with mvBarNinth 13000 elements.

FIGS. 150, 152, 154, 156, 158, 160, 162, 164, 166, 168, 170, 172, 174, 176, 178 and 180 each show a crate filled with ten bars. Each of them demonstrates an alternative, useful type of count helper shape. The count helper shapes are configurations of lines. The lines used for them are thick, to make them stand out. Like with count helper 400, each count helper facilitates counting of the amount of bars that are stored in the crate that it is are overlaying. Although the figures illustrate the count helpers on top of crates that are filled with 10 bars, each crate could equally well have been filled with any amount of bars from zero to ten. Apart from facilitating the counting of the amount of bars within the crates, the count helpers also help to count the individual crates that they are overlaying, when these crates are stacked upon each other.

FIGS. 184 . . . 194 illustrate the use of an another example of count helper.

FIG. 184 shows another useful alternative mvCountHelper 18400, which is having a diamond shape delineation in its center, and is being used in one embodiment. The corners of the diamond shape are at a distance of approximately three times the height of an mvBarTenth from the center. A further delineation is provided by dashed lines 18402. They are being used to help visualize empty slots that can hold mvBarTenths. In one embodiment, they have a dithering to appear more tranquil. Semitransparent rectangle 18403 of some predetermined color helps to create a visual reference for a quantity of 5 mvBarTenths. In addition the thick lines of overlay grid 18401 enforce that visual reference and offer in addition firm visual references for quantities of 2, and 8 mvBarTenths. For example, if 7 mvBarTenths are stored in an mvCrate, like in FIG. 194, the amount could be interpreted as “two above 5” or “one below 8”.

FIG. 186 shows an alternative (empty) mvCrate 18600, which is based on alternative mvCountHelper 18400a in combination with mvCrateDelimiter 200a.

FIG. 188 Shows filled alternative mvCrate 18800, which consists of alternative mvCrate 18600a, and the 10 mvBarTenths 800s it is filled up with. The transparent rectangular lower side of the mvCountHelper causes the lower 5 mvBarTenths to be displayed in a slightly different color and/or brightness. The borders of the mvBarTenths coincide with the dotted lines of the mvCountHelper, such that these dotted lines will not or almost not be visible. In another embodiment, the dotted lines are drawn behind the mvBars, rather than overlaying them.

FIG. 190 Shows filled alternative mvCrate 19000, which consists of alternative mvCrate 18600b, and the 10 mvBarTenths 1000s it is filled up with. Note that the transparent rectangular lower side of the mvCountHelper causes the lower 5 mvBarTenths to be displayed in a slightly different color and/or brightness. The borders of the mvBarTenths coincide with the dotted lines of the mvCountHelper, such that these dotted lines will not or almost not be visible. In another embodiment, the dotted lines are drawn behind the mvBars, rather than overlaying them.

FIG. 192 Shows partially filled alternative mvCrate 19200, which consists of alternative mvCrate 18600c, and the 3 mvBarTenths 800t it is filled up with. The transparent rectangular lower side of the mvCountHelper causes the lower 3 mvBarTenths to be displayed in a slightly different color and/or brightness. The dotted lines above the third mvBarTenth are clearly visible, and thus help to count the empty spots.

FIG. 194 Shows partially filled alternative mvCrate 19400, which consists of alternative mvCrate 18600d, and the 7 mvBarTenths 1000d it is filled up with. The transparent rectangular lower side of the mvCountHelper causes the lower 5 mvBarTenths to be displayed in a slightly different color and/or brightness. The dotted lines above the seventh mvBarTenth are clearly visible, and thus help to count the empty spots.

FIG. 200 illustrates an example of an additional embodiment of three piles of mvCrates, which are stacked upon mvPileLocations 1200k, 1200m and 1200n. The mvCrates 600m, 600p and 600q are each at the top of a pile. These mvCrates comprise mvCrateDelimiters as is shown in FIG. 6. The top parts of these mvCrateDelimiters of mvCrates 600m, 600p and 600q are removed. The figure shows mvCrate 600n as well, which is not at the top of a pile. The mvCrateDelimiters of all mvCrates comprise lines that alternate between two colors in a randomized manner. mvCountHelpers 400b, 400c, 400d and 400e comprise lines that alternate between two colors in a randomized manner. mvBarGuideLineTenths 20002, 20002a and 20002b have been added to the back of mvCrate 600m, 600p and 600q, respectively. Similar but more general, mvBarGuideLines are used as objects that help to count mvBars. In one embodiment, mvBarGuideLines overlay any mvBars in the mvCrate. In another embodiment, mvBarGuideLines are shown at the back of the mvCrate, “behind” any mvBars stacked inside the mvCrate. They act as separators of the empty slots in an mvCrate. In this example, the mvBarGuideLine is a double color randomly dashed line that separates empty positions within an mvCrate that can hold an mvBar. An mvBarGuideLineTenth is an mvBarGuideLine that applies to mvBarTenths. In this case, the mvBarGuideLineTenths are represented by a two color randomized dash pattern. Below each pile, an mvNumberDisplay that relates to that pile is shown: 20001, 20001a and 20001b respectively. An mvNumberDisplay is a notation shown on the display device using textual digits, and represents a numeric quantity that is associated with the sum of the individual values that are associated with the mvBars in the pile that it is related to. In this case, the value associated with a single mvBar is one. In the case of fractional values (see FIG. 240), mvNumberDisplay may show different results, with divisional lines as well.

FIG. 202 illustrates the result of an example wherein starting from the state that is illustrated in FIG. 200, user initiated transfers have caused the mvBarTenths 800r and 800p (in that order) from the mvCrates from the third and first pile to be stacked upon the mvBarTenths 800q of the second pile. The figure shows mvPileLocations 1200k, 1200m and 1200n. The mvCrates 600n, 600p and 600s are stacked on top of mvPileLocation 1200m. These mvCrates comprise mvCrateDelimiters as is shown in FIG. 6. Below each pile, an mvNumberDisplay that relates to that pile is shown: 20001, 20001a and 20001b respectively.

FIG. 240 illustrates an example of an additional embodiment that is identical to the embodiment of FIG. 200, except for the values that are displayed in the mvNumberDisplays. The numeric value that is associated with a single mvBarTenth is one tenth now, whereas in the example of FIG. 200, it was one. There are three piles of mvCrates, which are stacked upon mvPileLocations 1200k, 1200m and 1200n. The mvCrates 600m, 600p and 600q are each at the top of a pile. These mvCrates comprise mvCrateDelimiters as is shown in FIG. 6. The top parts of these mvCrateDelimiters of mvCrates 600m, 600p and 600q are removed. The figure shows mvCrate 600n as well, which is not at the top of a pile. The mvCrateDelimiters of all mvCrates comprise lines that alternate between two colors in a randomized manner. mvCountHelpers 400b, 400c, 400d and 400e comprise lines that alternate between two colors in a randomized manner. mvBarGuideLineTenths 20002, 20002a and 20002b have been added to the back of mvCrate 600m, 600p and 600q, respectively. In this case, the mvBarGuideLineTenths are represented by a two color randomized dot pattern. Below each pile, an mvNumberDisplay that relates to that pile is shown: 20001c, 20001d and 20001e respectively.

FIG. 280 illustrates an example of an alternative embodiment comprising a wood industry theme. In this case, the mvCrates 600r, 600s, 600t, 600u, and 600v comprise images of 3d chains. mvPileLocations 1200p and 1200q comprise images of wooden pallets. A hook 28000 appears when a transfer of mvCrate 600s is initiated by the user at the mvTouchLocation that is indicated by mvHandPointer 1300f. The top of mvCrate 600s is closed. The top of mvCrate 600v is open. In this example, mvCrates 600r, 600s, 600t and 600u are filled with dark colored wood logs, while mvCrate 600v is filled with lighter colored wood logs.

FIG. 298 illustrates examples of mvReservoirLocation 29800 and mvTrashLocation 29801. An mvReservoirLocation is an mvPileLocation that indicates the location of a pile with so called “reservoir properties”: the pile consists of at least one mvCrate that is being mvFull while available for user initiated transfer at all times. An mvTrashLocation is an mvPileLocation that indicates the location of a pile with so called “trash can properties”: a user can drag a selection of elements to that pile, resulting in the destruction of that selection of elements.

FIG. 300 illustrates an example of one embodiment that can be used to set up a set of piles, in this example the piles that are stacked on mvPileLocations 1200r and 1200s. mvCrate 1600f is stacked on top of mvReservoirLocation 29800a. On top of that, mvCrate 1800c is stacked. mvCrate 1600g is stacked on top of mvPileLocation 1200p. On top of that, mvCrate 1800d is stacked. mvCrate 2200k is stacked on top of mvPileLocation 12000q. On top of that, mvCrate 2400h is stacked. At the right, there is mvTrashLocation 29801a. Furthermore, an mvBarStylePalette 30000 is shown, which comprises mvBarStylePaletteEntries 30001 and 30001a. An mvBarStylePalette is a graphical representation of a collection of mvBarStylePaletteEntries. An mvBarStylePalette entry is a user selectable graphical representation of the style that defines how one or more mvBars are to be displayed. In the example of FIG. 300, after mvBarStylePaletteEntry 30001 has been selected by the user, the mvBars in the pile that is stacked on top of mvReservoirLocation 29800a are transformed such that they comply to the style that corresponds to that mvBarStylePaletteEntry, which means: a rectangle of a light color. In the same example, after mvBarStylePaletteEntry 30001a has been selected by the user, the mvBars in the pile that is stacked on top of mvReservoirLocation 29800a are transformed such that they comply to the style that corresponds to that mvBarStylePaletteEntry, which means: a rectangle of a darker color.

FIG. 303 illustrates an example of mvStoreAndRetrieveLocation 30300 with attached to it mvStoreAndRetrieveSymbol 30301. An mvStoreAndRetrieveLocation is an mvPileLocation that indicates the location of a pile that is bestowed with both reservoir properties and trash can properties. It thus combines the functionality of an mvReservoirLocation 29800 and an mvTrashLocation 29801. An mvStoreAndRetrieveSymbol is a symbol that shows the user that the nearby mvPileLocation actually is an mvStoreAndRetrieveLocation.

FIG. 306 illustrates an example of one embodiment that can be used to set up a set of piles, in this example the piles that are stacked on mvPileLocations 1200t and 1200u. mvCrate 1600i is stacked on top of mvStoreAndRetrieveLocation 30300a. That mvStoreAndRetrieveLocation is marked by mvStoreAndRetrieveSymbol 30301a. mvCrate 1600j is stacked on top of mvPileLocation 1200t. On top of that, mvCrate 1800e is stacked. mvCrate 22001 is stacked on top of mvPileLocation 1200u. On top of that, mvCrate 2400i is stacked.

The paragraphs above focus on aspects involving graphical representations of the embodiments. The next set of paragraphs mainly focus on process flows according to some aspects of the present invention.

### Process

The process discussion is about the transfer of mvBars from one pile to another. That transfer can be initiated by either a physical player or a virtual artificial intelligence player. The supported manners of selection of the mvBars that are to be transferred, as well as the behavior of the piles during the transfer is defined by the formulation of an orthogonal set of process rules, which can be subsequentially referred to in order to keep the discussion compact.

Process rule 1: at any time, the mvBars that are part of a pile of mvBars are contained/delimited in mvCrates. As a consequence of this process rule, a pile of mvBars implies a pile of mvCrates as well.

Process rule 2: when an mvCrate gets empty, it will be removed. Thus piles of mvCrates only contain mvCrates that are either mvFull or partly filled.

To keep the discussion compact and comprehensible, some definitions on the subject of selection and dragging are introduced next.

The mvTouchDown state is a boolean state, that can have the value true or false. In the case that the touch sensing electronics within a touchscreen is used as input device, mvTouchDown is true while a finger is being pressed against that touch screen, and false otherwise. In the case that a mouse is used as input device, mvTouchDown is true while a predetermined mousebutton is being held pressed, and false otherwise.

The mvTouchLocation is a two-coordinate (x,y) location value, which reflects a location on the electronic display device while mvTouchDown equals true. If mvTouchDown is false, its value is unused and thus redundant. In the case that a touch screen is used as input device, mvTouchLocation represents the current location where a finger is currently being pressed against that touch screen. In the case that a mouse is used as input device, mvTouchLocation represents the location of the mouse pointer while the predetermined mouse button is being held pressed that causes mvTouchDown to be equal to true.

An mvDraggingPath is a path that is defined by the user changing the mvTouchLocation while mvTouchDown equals true. In all figures where a phantom arrow trails the mvHandPointer, that phantom arrow defines an mvDraggingPath.

An element is said to be mvDragLocked when the difference between the mvTouchLocation and the momentary location of that element is frozen. The element thus moves along with the mvTouchLocation in a synchrone manner if it is mvDragLocked.

An element is said to be mvDragged if that element is in an mvDragLocked state and is moved as a result of movement of mvTouchLocation.

When a transfer of mvBars from one pile to another takes place, the pile that the mvBars come from will be referred to as the source pile, while the pile that the mvBars are transferred to will be referred to as either the target pile or the drop off pile.

A transfer of mvBars from a source pile to a target pile consists of a selection step, which mvDragLocks one or more mvBars in some way, followed by an mvDraggingPath toward another pile. There, the user concludes the transfer by changing mvTouchDown to false (as the user either releases the predetermined mouse button or withdraws his finger from the touchscreen).

Said selection step is limited to one of next three manners: 1. Selection of an mvCrate (this case is further differentiated in the next paragraph). 2. Selection of a consecutive sequence of mvBars from the top of the top mvCrate by picking (FIGS. 52,54). 3. Selection of the top mvBar from the top mvCrate by peeling (FIGS. 70,72).

In the case of the selection of an mvCrate, the source pile behaves in one of three manners: 1. Like in FIGS. 40,42 in case that the selected mvCrate was partially filled. 2. Like in FIGS. 58,60 in case that the selected mvCrate is mvFull while another mvCrate is stacked on top of it. 3. Like in FIGS. 45,46 in case that the selected mvCrate is mvFull while no other mvCrate is stacked on top of it.

For the target pile, the behavior differs in one of three manners. 1. In case that an mvPackage or an mvCrate that is non-mvFull is transferred to it, it is like in FIGS. 54,56 and FIGS 42,44. 2. In case that an mvCrate that is mvFull is transferred to it, while the top mvCrate of the target pile was non-mvFull, prior to the transfer, it is like in FIGS. 48,50. 3. In case that an mvCrate that is mvFull is transferred to it, while the top mvCrate of the target pile was mvFull, prior to the transfer, it is like in FIGS. 60,62.

Note that the cases involving the source pile and the target pile behaviors are orthogonal. That is, the behavior case of the source pile does not influence the behavior case of the target pile for a given transfer and vice versa (of course insofar as that the transferred element must be the same). The next paragraphs discuss the behavior in all of these cases in more detail, and formulates a process rule for each of them.

FIGS. 40, 42 and 44 together illustrate an mvCrate transfer. The mvCrate transfer is initiated in correspondence to Process rule 3: The mvCrate is selected in one of two ways: 1. Start an mvTouchDown (changing it from false to true) near one of its (left or right) sides. 2. Start the mvTouchDown elsewhere, but follow a dragging path that closely approaches one of the (left or right) sides of the mvCrate. FIG. 40 shows the moment that the mvCrate is subsequentially mvDragLocked. FIG. 42 shows the subsequent transfer of mvCrate 1800a to the right pile as the user follows an mvDraggingPath such that the selected mvCrate comes to hover over that pile, the mvDraggingPath being indicated by the phantom arrow that trails mvHandPointer 1300a. FIG. 44 shows the end result of the transfer, after the user has reset mvTouchDown to false (by releasing mouse button or lifting finger from touchscreen). From this case, two new process rules follow. Process rule 4: if the top mvCrate is selected from a source pile for transfer to another pile, it is mvDragLocked as a whole, while no mvCrateGhost needs to be shown. Process rule 5: if the mvBars that are selected for transfer are not inside an mvCrate that is mvFull, then it has next consequence: the transferred mvBars are added at the top of the target pile. If the mvCrate at the top of the target pile becomes mvFull while not all mvBars are transferred yet, a new mvCrate is spawned at the top of the target pile, to contain the remainder of these mvBars.

FIGS. 45, 46, 48 and 50 together illustrate the transfer of an mvCrate that is mvFull. The mvCrate is selected in one of two ways, the same as with the selection of a non-mvFull as discussed in the previous paragraph. Like in the previous paragraph, process rule 3 applies. After the mvDragLock that comes with the selection of mvCrate 1600a, the user follows an mvDraggingPath as indicated by the phantom arrow that trails mvHandPointer 1300a such that the selected mvCrate hovers over that pile. As the target pile contains an mvCrate at its top that is non-mvFull, it moves up to create space to be able to insert the mvCrate 1600a that is being dragged. While mvTouchDown is still true, in that space, mvCrateGhost 32000a is displayed, which is a ghost copy of mvCrate 1600a. FIG. 50 shows the end result of the transfer, after mvTouchDown has been reset to false. Process rule 6: in the case that an mvCrate that is mvFull is transferred to a target pile, it is inserted above the topmost mvFull mvCrate of that target pile. So in this case, that implies that it is inserted in between mvCrate 2400a and mvCrate 600g.

FIGS. 52, 54 and 56 together illustrate the transfer of an mvPackage of mvBars from a source pile to a target pile using the method of picking, in correspondence with Process rule 7: A selection that is involved with picking is made by starting an mvTouchDown (setting it to true) at a location within an mvBar that is inside the top mvCrate of the source pile. Right at that start, said mvBar and all mvBars above it are mvDragLocked, and packed in an mvPackageDelimiter, thus constituting an mvPackage. In FIG. 54, that is mvPackage 2800a. The transferred units are added to the top mvCrate 2400b, in correspondence to process rule 5.

FIGS. 58, 60 and 62 together illustrate the transfer of an mvCrate 1600b that has another mvCrate 600h on top of it in the source pile, toward a target pile that has no partially-empty mvCrate at its top. The transfer of mvCrate 1600b takes place in accordance with the third process rule. However, as FIG. 58 shows that said mvCrate originally had another mvCrate 600h on top of it, such that Process rule 8 applies: during the transfer of an mvCrate that had another mvCrate on top of it in the source pile prior to the transfer, an mvCrateGhost is shown at the original location of the mvCrate that is being transferred. In FIG. 60, mvCrateGhost 3200b fulfills that function. As for the finalization of the transfer, the behavior of the target pile is covered by process rule 6. In this case, the behavior of the source pile, is defined by Process rule 9: after finalizing a transfer, any mvCrateGhost is removed, and the mvCrates that were stacked on top of it move down, removing the gap that its removal left. In FIG. 62, that movement is indicated by the phantom arrow pointing downward.

FIGS. 70, 72 and 74 together illustrate the transfer of a single mvBar from the left pile to the right pile, using the method of peeling, as is formulated by the Process rule 10: A selection that is involved with peeling off the topmost mvBar from the topmost mvCrate of a source pile is made by starting an mvTouchDown (setting it to true) at a location that is above the topmost mvBar and approximately halfway in between the left side and the right side of the topmost mvCrate of the source pile. After that, the user must follow an mvDraggingPath that goes downward toward said topmost mvBar in an approximately vertical manner. When the mvTouchLocation is within that mvBar, that mvBar is mvDragLocked. From that moment on, the user can complete the transfer as usual by following a subsequent mvDraggingPath that makes the mvBar hover over the target pile and resetting mvTouchDown subsequentially to false to conclude the transfer. In the example of FIG. 70, the first part of the mvDraggingPath is started at the location where mvHandPointer 1300c is shown. The phantom arrow trailing the mvHandPointer 1300c in FIG. 72 indicates the full mvDragPath that the user has followed to direct the transfer of mvBarTenth 800i. The transfer is concluded in conformance with process rule 5.

FIGS. 76, 78 and 80 together illustrate the transfer of a single mvBar from the left pile to the right pile, using the method of peeling. Opposed to the example of the previous paragraph as illustrated in FIGS. 70, 72 and 74, this time the topmost mvCrate 600j from which mvBarTenth 800j is being peeled off, is mvFull. Still, the behavior of this situation is covered by the same process rules. That is, the peeling off selection conforms to process rule 10, while the transfer is concluded in conformance with process rule 5.

FIGS. 82,83 and 84 together illustrate the transfer of an mvPackage of mvBars from a source pile to a target pile using the method of picking. Opposed to the example that is illustrated in FIGS 52, 54 and 56, this time the topmost mvCrate 600k from which the group mvBarTenths 800m are picked off, is mvFull. Still, the behavior of this situation is covered by the same process rules. That is, the picking off selection confirms to process rule 7, while the transfer is concluded in conformance with process rule 5.

FIGS. 100-130 show additional types of mvBars, which are used to represent fractions in one or more embodiments. (more: see discussion on operation of FIG. 240).

FIG. 200 illustrates an example of an embodiment comprising three piles of mvCrates. From a process point of view, there is not much difference with respect to for instance the embodiment shown in FIG. 82. In the case of FIG. 200, there are three piles rather than two, and mvNumberDisplays 20001, 20001a and 20001b are automatically updated as soon as the amount of mvBars that is in the pile that they are associated with is changed. That way, each mvNumberDisplay keeps reflecting the value of the numerical sum of the values of the individual mvBars that each pile contains. In this example, the value of an individual mvBar is identical to 1.

FIG. 202 illustrates the result of user initiated transfers of mvCrates 600q and 600m of FIG. 200 (in that order) onto mvCrate 600n. The process rules that are in force during these transfers are the same as those postulated in the discussions of FIG. 40 till FIG. 74 above.

FIG. 240 illustrates an example of an additional embodiment that is identical to the embodiment that is illustrated in FIG. 200, except for the way that the values that are displayed in the mvNumberDisplays are generated. The numeric value that is associated with a single mvBarTenth is one tenth now, whereas in the example of FIG. 200, it was one. In a similar way, instead of using mvBarTenths, together with mvCrates that comprise mvBarGuideLineTenths, mvBarNinths, representing a numeric value of one ninth could be used, together with mvCrates that comprise mvBarGuideLineNinths. The same goes for mvBarEighths, representing a numeric value of one eighth and mvBarGuideLineEighths, mvBarSevenths, representing a numeric value of one seventh with mvBarGuideLineSevenths, mvBarSixths, representing a numeric value of one sixth with mvBarGuideLineSixths, mvBarFifths, representing a numeric value of one fifth with mvBarGuideLineFifths, mvBarFourths, representing a numeric value of one fourth with mvBarGuideLineFourths, mvBarThirds, representing a numeric value of one third with mvBarGuideLineThirds and mvBarHalfs, representing a numeric value of one half with mvBarGuideLineHalfs.

Here, an mvBarGuideLineNinth is an mvBarGuideLine that applies to mvBarNinths.
An mvBarGuideLineEight is an mvBarGuideLine that applies to mvBarEights.
An mvBarGuideLinemvBarSeventh is an mvBarGuideLine that applies to mvBarmvBarSevenths.
An mvBarGuideLineSixth is an mvBarGuideLine that applies to mvBarSixths.
An mvBarGuideLineFifth is an mvBarGuideLine that applies to mvBarFifths.
An mvBarGuideLineFourth is an mvBarGuideLine that applies to mvBarFourths.
An mvBarGuideLineThird is an mvBarGuideLine that applies to mvBarThirds.
An mvBarGuideLineHalf is an mvBarGuideLine that applies to mvBarHalfs. These additional mvBar types are shown in FIGS. 100-128.

FIG. 300 illustrates an example of one embodiment that can be used to set up a set of piles, in this example the piles that are stacked on mvPileLocations 1200r and 1200s, while an mvReservoirLocation 29800a provides a location where new mvBars can be drawn from. In one embodiment, the behavior of the pile at the mvReservoirLocation is implemented in such a way that at the bottom of the pile, an new mvCrate that is mvFull is added as soon as the pile does no longer contain at least one mvCrate that is mvFull. In one embodiment, that addition is animated by pushing the original pile up from the ground/mvReservoirLocation, much like a plate rack in a restaurant works. In one embodiment, it is allowed to drag mvBars and mvCrates toward the pile of mvReservoirLocation as well. In one embodiment, the use of an mvTrashLocation is omitted, as the mvReservoirLocation can be used to drag mvBars that need to be disposed of instead. In one embodiment, as soon as on top of the mvReservoirLocation more than one mvCrate is mvFull, the bottom mvCrates that are mvFull are removed until the condition is met that on top of the mvReservoirLocation there is only one mvCrate that is mvFull. In one embodiment, that removal is animated by letting the pile sink, such that the superfluous mvCrates sink away into the ground/mvReservoirLocation, again, much like a plate rack in a restaurant.

FIG. 306 illustrates an example of one embodiment that can be used to set up a set of piles, in this example the piles that are stacked on mvPileLocations 1200t and 1200u. An mvStoreAndRetrieveLocation 30301a is an mvPileLocation on which a pile consisting of exactly one mvCrate 1600i that is being mvFull and for which the contained bars have a predetermined color. In one embodiment, that color could be cycled to other predetermined colors by one or more mvTouchDowns at the location of mvStoreAndRetrieveSymbol 30301a. The mvFull mvCrate 1600i is available for user initiated transfer at all times. That is, either that entire mvCrate itself or a group of mvBars could be dragged away from the mvStoreAndRetrieveLocation toward any other mvPileLocation. In such case, the stack on mvStoreAndRetrieveLocation is automatically replenished to a single mvCrate that is mvFull. Apart from its function as a source to draw mvCrates or mvBars from, mvStoreAndRetrieveLocations offer trash can functionality as well. mvCrates, groups of mvBars or individual mvBars can be dragged from other mvPileLocations upon an mvStoreAndRetrieveLocation for destruction. As a result of such a dragging, the appearance of the applicable mvStoreAndRetreiveLocation remains unchanged. It will remain holding exactly one mvFull mvCrate.

One embodiment of the invention is implemented as a process that supports the transfer of mvBars and mvCrates with mvBars from one pile to another pile. That process is represented in three parts by means of the flow diagrams in FIGS. 340, 360 and 380, respectively.

FIG. 340 illustrates the part of the process that supports the transfer initiations. It gives the user a restricted set of possibilities to start the transfer of one or more mvBars or an mvCrate. At step 34002, the process is waiting for the user to make a selection of an mvCrate or mvBar, using one of the techniques of side selection, peeling or picking as explained above. As soon as such a selection has been made, step 34006 checks whether an mvCrate or an mvBar is selected. In the case that an mvCrate is selected, step 34010 checks if that mvCrate was at the top of a pile at the moment of selection. If that appears to be the case, the selected mvCrate is made mvDragLocked right away at step 34014. If not, step 34014 still ensues, but only after step 34012, which spawns an mvCrateGhost on the original position of the selected mvCrate. In case the check of step 34006 determines that an mvBar is selected instead, step 34008 ensues, which tests if the selected mvBar was in the top mvCrate of the pile that contained it at the moment of selection. If the result of test 34008 is negative, the mvBar selection is ignored altogether, and the wait for a new selection at step 34002 can begin once more. If the result of test 34008 is positive, step 34016 ensues. At that step, it is tested if the selected mvBar is at the bottom at the moment that its selection took place. If that is the case, step 34020 follows, where the mvCrate it was selected from (including mvCrateDelimiter, mvCountHelper, etc.) is removed, except for its mvBar contents, which are retained. If not, the mvCrate that was selected from is retained. Either way, step 34018 follows, which checks if any mvBars are being stacked above the selected mvBar at the moment of its selection. If that appears to be the case, the entire stack of mvBars consisting of the selected mvBar and all mvBars stacked above it are made to be mvDragLocked. If not, only the selected mvBar itself is made to be mvDragLocked. In either way, after that we have the situation that a stack of one or more selected mvBars that are mvDragLocked, which is the start condition for the transfer finalization process in FIG. 360.

FIG. 360 illustrates the part 36000 of the process that supports the finalization of the transfer of a stack of one or more selected mvBars that are being mvDragLocked, as is shown in initial state 36002. It gives the user the possibility to drop off the selected elements onto another pile. Depending on the specific situation, what exactly happens after such a drop off depends on the situation, as is shown in the flow diagram. Step 36006 effectively waits till the user has caused mvTouchDown to become false, for instance by lifting his finger from the touchscreen, in case of a hand held mobile device. After a successful wait, at step 36010, the selected stack of mvBars is made to be no longer mvDragLocked. Step 36014 tests if the stack of selected mvBars is hovering over a pile at that moment. If not, the user didn't properly specify a transfer, and the state is restored to the situation that was valid prior to the transfer initiation. If the stack of selected mvBars is hovering over the original pile that the stack originated from, the result is the same, as is decided by test 36020. Only if the stack of selected mvBars is hovering over a different pile than the one that the stack originated from, then the transfer can be completed toward that target pile. If the target pile is empty prior to the transfer (test 36004) or the stack of selected mvBars does not entirely fit in the top mvCrate of the pile (test 36008), an empty mvCrate is created and stacked on top of the target pile. Whether the latter is the case or not, after that, the transfer is completed in step 36018, where mvBars of the selected stack are being piled on top of any present mvBars within the lowest non-mvFull mvCrate of the target pile. If they don't fit all of them in that mvCrate, the surplus is piled in the newly created mvCrate on top of that mvCrate.

FIG. 380 illustrates the part 38000 of the process that supports the finalization of the transfer of a selected mvCrate that is being mvDragLocked, as is shown in initial state 38002. It gives the user the possibility to drop off the selected mvCrate onto another pile. Depending on the specific situation, what exactly happens after such a drop off depends on the situation, as is shown in the flow diagram. Step 38004 effectively waits till the user has caused mvTouchDown to become false, for instance by lifting his finger from the touchscreen, in case of a hand held mobile device. After a successful wait, at step 38016, the selected mvCrate is made to be no longer mvDragLocked. Step 38016 tests if the selected mvCrate is hovering over a pile at that moment. If not, the user didn't properly specify a transfer, and the state is restored to the situation that was valid prior to the transfer initiation (step 38028). If the selected mvCrate is hovering over the original pile that the mvCrate originated from, the result is the same, as is decided by test 38022. Only if the selected mvCrate is hovering over a different pile than the one that the mvCrate originated from, then the transfer can be completed toward that target pile. If the selected mvCrate is not mvFull (test 38006), it is treated much like the stack of mvBars in the previous example. Actually, the stack of mvBars that is stored in the mvCrate is effectively extracted, while the rest of the crate is destroyed, upon which that stack of mvBars can be treated identical as in the steps 36004, 36008, 36016 and 36018 of FIG. 360. That is, if the target pile is empty prior to the transfer (test 38010) or the mvBars inside the selected mvCrate would not entirely fit in the top mvCrate of the target pile (test 38018), an empty mvCrate is created and stacked on top of the target pile (step 38024). Whether the latter is the case or not, after that, the transfer is completed in step 38030, where mvBars out of the selected mvCrate are being piled on top of any present mvBars within the lowest non-mvFull mvCrate of the target pile. If they don't fit all of them in that mvCrate, the surplus is piled in the newly created mvCrate on top of that mvCrate. The thus emptied selected mvCrate is destroyed thereafter. If from test 38006 it appears that the selected mvCrate is mvFull, the behavior is different. In case that the target pile has a non-mvFull mvCrate at its top (test 38012), the selected mvCrate is inserted just below that non-mvFull mvCrate (action 38020). Otherwise, the selected mvCrate is simply piled upon the top of the target pile (action 38014). In either way, if an mvCrateGhost was spawned during the transfer initiation, at this point (action 38026) it will be removed from the source pile (the pile where the selected mvCrate originated from), and the stack of mvCrates that was stacked on top of it sinks downward to remove the empty gap that thus initially exists (as illustrated in FIG. 62). It is noted that use of mvCrateGhosts is optional.

While FIGS. 340, 360 and 380 show at least one example of an implementation of the present invention, which represents the steps that are required to support a restricted set of ways in which mvBars can be transferred from one pile to another, with these steps occurring in a specific order, it should be appreciated that the order of these steps may be altered and remain within the scope and spirit of the present invention.

### Advantages

From the description above, a number of advantages of some embodiments of the pile manipulation game become evident:

(a) Number sense of double digit quantities is provided by displaying these digits below the piles, where the height of the pile of mvFull mvCrates is identical to the value of the digit that represents the tens, while the amount of mvBars in any non-mvFull topmost mvCrate is identical to the value of the digit that represents the units. At the same time, the height of the total pile is directly proportional to the total quantity that is represented by the number that these digits represent together.
(b) In a similar manner as with advantages (a), number sense of fractional quantities is provided.
(c) Number sense is further enhanced by using approximately square containers that have room for an amount of elements that equals the overflow value.
(d) Number sense is further enhanced by displaying count helpers in front of as well as behind the elements that are contained in the containers, which offer the possibility of counting quickly, in a similar way that the appearance of a dice roll shows a value without much need for counting. As a result, children will be able to give more attention to the numerical process itself.
(e) Grouping into a ten occurs automatically as a crate gets filled. There's no need to manually keep track of the amount of unit objects and to replace them with a ten object, which is required when using physical objects of the Montessori stacking system. This too, will help children will to spend less of their attention to bookkeeping and counting, such that more attention can be given to the numerical process itself.
(f) Application of randomized multi-color dashed lines softens up the periodical nature and makes counting easier.
(g) The behavior of the pile manipulation game removes the need to teach the user how to make groups and how to geometrically organize them, as is common with prior art.
(h) The use of a reservoir and/or trash location facilitates teachers to use the pile manipulation game to prepare an exercise for one or more of their pupils, or to use it to demonstrate numerical principles, like for instance on a smartboard.
(i) The behavior of the pile manipulation game enforces restrictions to the user that encourage him to make transfers that coincide with recommended logical steps in the process of making mental calculations. For instance:
(i1) Tens are modeled by full crates. Operations with tens are modeled by movement of these full crates to other piles. That is, there is no need to “open up” an existing ten to move a ten, which for instance would be required in case of Bead Bar Games. The concept of a ten in the Pile Manipulation Game therefore provides a better foundation for solving exercises in formal ways.
(i2) The maximum quantity that can be moved in a single move is limited to a single mvCrate. If it is mvFull, its value equals ten. If it is non-mvFull, its value equals the least significant digit of the number that is displayed below the pile it is selected from. Because of that, children are encouraged to think in terms of adding or subtracting units and tens separately, which provides a solid foundation for solving formal exercises, which depends on treating tens and units separately as well.
   (j) Children can develop number sense as well as learn to understand the rules for mental calculations concurrently. For instance, even children that cannot count till 99 yet can already start practicing with pile manipulation games that allow them to solve mathematical exercises involving any double digit numbers.
   (k) The aforementioned concurrency provides an additional context of usability to the children, which increases their motivation to learn the numbers themselves as well.
   (l) The use of animations and ghosts help to give the user a feel of control and understanding.
   (m) Compared to other methods, as mentioned in the prior art discussion, the Pile Manipulation Game provides children a means to practice and learn to understand exercises with less amount of teaching effort required. Because of that, it enables teachers to free up time, such that for example, more time can be spend on individuals that are lagging behind.

### CONCLUSION, RAMIFICATION AND SCOPE

Accordingly, the reader will see that various embodiments allow children to develop number sense and learn mathematical principles for double digit numbers in a parallel, more insightful and intuitive way than any prior art currently known. In addition, apart from learning to understand these mathematical principles more easily, children are encouraged to learn preferred ways of mental calculation, and create a solid foundation for solving formal exercises at a later stage. Children can learn all of this with less teaching effort required from a teacher.

mvBarGuideLines are just but one representation of the possible count helpers at the back side of the crate that serve this purpose. I contemplate that for instance, instead of showing the (dashed-) lines, the rectangular “empty slots” within the mvContainer that they discern, could be graphically represented by other types of approximately rectangular objects as well, either 2D or 3D, using any texturing, material or shaders applied on them.

In some embodiments, mvBars have been represented by colored rectangles, while sets of mvBars are being discerned from each other by using a different color for them. However, for the scope of the invention, mvBars are not limited to colored rectangles. They have the approximate rectangular size and shape that is discussed above, but may have less straight shapes, like rounded rectangles, look like 3d objects, employ texturing, shaders, colors, transparency, multi-color effects, etc. They can be discerned from each other by variation of any subset of these or other aspects.

In some embodiments, mvCountHelpers are used that comprise an overlay grid of solid lines, like 18401. In other embodiments, these lines may have different thickness, color, dash-pattern and transparency.

In some embodiments, mvCountHelpers are used that comprise a semitransparent rectangle to enforce or create a visual reference at a value of 5 (like mvCountHelper 18400). However, for the scope of the invention, use of semitransparent rectangles in mvCountHelpers is not restricted to a single one to create that visual reference. An additional one could be added or used instead to overlay the top 5 mvBarTenths.

In some embodiments, mvCountHelpers are used that comprise a semitransparent rectangle to enforce or create a visual reference at a value of 5 (like mvCountHelper 18400). However, for the scope of the invention, use of semitransparent rectangles in mvCountHelpers is not restricted to create a single visual reference at a value of 5. They can be used to create one or more visual references at any value that is less than the amount of mvBars that fits the mvCrate type that the mvCountHelper is associated with.

In some embodiments, mvCountHelpers are used that comprise a semitransparent rectangle to enforce or create a visual reference at a value of 5 (like mvCountHelper 18400). However, for the scope of the invention, instead of using semitransparent rectangles, hashed or otherwise patterned rectangles with transparent areas can be used for that purpose as well.

In some embodiments, at the start of the Pile Manipulation Game, each pile only contains mvBars of a single color. However, for the scope of this invention, the initialization of piles is not restricted to a uniform color selection for the mvBars it holds. For example, the mvBars in the topmost, non-mvFull mvCrate (the units) could be initialized with a brightness or saturation that is different from the mvBars that populate the mvFull mvCrates in the same pile.

In some embodiments, mvBars have a constant color since the initialization of the Pile Manipulation Game. However, the scope of this invention is not limited to mvBars that have a constant color. For example, in the absence of a colored transparent rectangle as part of the mvCountHelper as in FIG. 184, the 5-structure could alternatively be emphasized by dynamically updating the color of the mvBar, depending on whether it is mvDragged into an even or an odd five fold at any given moment. So for example, the bottom 5 mvBars of each mvCrate could be colored red, while the top 5 mvBars of each mvCrate could be colored white.

In one embodiment, mvFull mvCrates that are mvDragged onto a pile are inserted in that pile at the top of any existing mvFull mvCrates, yet below any existing non-mvFull mvCrate. The scope of this invention is not limited to that. For example, in addition it could be allowed that mvFull mvCrates that are mvDragged onto a pile may be inserted below any of the mvCrates currently existing in that pile.

In one embodiment, an empty pile consists of an mvPileLocation without any mvCrates on top of it. In another embodiment, an empty pile may consist of an mvPileLocation with an empty mvCrate on top of it.

Examples of embodiments comprising two or three piles are being shown. However, the scope of the invention is not limited to these amounts of piles. Any feasible number of piles may be used.

Examples have been shown of embodiments comprising piles that have a height of zero, one, two or three mvCrates. However, for the scope of the invention, the maximum pile heights are not limited to these pile heights. Any feasible maximum pile height may be used instead.

For each embodiment, the set of options for the user to initiate a transfer may comprise any subset of the set consisting of “selection of mvCrate”, “picking stack of mvBars from top of top mvCrate” and “peeling single mvBar from top of top mvCrate”, with each of these transfer initiations as discussed above. Some embodiments use mvCrateGhosts in source piles and/or target piles to improve the feel of control of the user, while other embodiments may omit that improvement.

Some embodiments show mvNumberDisplays below the piles. Other embodiments may omit them, for example in case the game is played at a higher level of difficulty. Other embodiments may show the mvNumberDisplays at other locations than below the piles they are associated with.

Some embodiments show that stacks of mvBars that are being transferred without being delimited by an mvCrate, are delimited by an mvPackageDelimiter instead. However, the scope of the invention is contemplated to include variations of these embodiments that omit the delimitation by mvPackageDelimiters of stacks of mvBars that are being transferred. For example, another embodiment always omits delimitation by mvPackageDelimiters of stacks of mvBars that are being transferred. Another embodiment only omits delimitation by an mvPackageDelimiter in the case that a single mvBar is being transferred.

Examples of embodiments that show all mvBars being contained in mvCrates are being shown. However, the scope of the invention is contemplated to include other embodiments as well, whereby the top mvCrate of each pile can be omitted, displaying the associated mvBars without it: In one embodiment, the top mvCrate of each pile is always omitted. In another embodiment, the top mvCrate of a pile is omitted if and only if that mvCrate is non-mvFull.

The possible graphical representations of the mvReservoirLocation, mvTrashLocation and mvStoreAndRetrieveLocation are not limited to those shown in FIG. 298 and FIG. 303. For example, in one embodiment the mvTrashLocation could be marked by a trash can image instead of a series of arrows pointing down.

A large part of next description and some of the figures it references to, is similar to those used in patent U.S. Pat. No. 8,118,667 B2 (Feb. 21, 2012, Herrmann).

The processes described above are merely part of an illustrative embodiment of a method for providing pile manipulation functionality. Such illustrative embodiments are not intended to limit the scope of the invention, as any of numerous other implementations for performing the invention. None of the claims set forth below are intended to be limited to any particular implementation of a method of providing pile manipulation functionality, unless such claim includes a limitation explicitly reciting a particular implementation.

Processes and methods associated with various embodiments, acts thereof and various embodiments and variations of these methods and acts, individually or in combination, may be defined by computer-readable signals tangibly embodied on a computer-readable medium, for example, a non-volatile recording medium, an integrated circuit memory element, or a combination thereof. Such signals may define instructions, for example, as part of one or more programs, that, as a result of being executed by a computer, instruct the computer to perform one or more of the methods or acts described herein, and/or various embodiments, variations and combinations thereof. Such instructions may be written in any of a plurality of programming languages, for example, Java, Visual Basic, C, C#, or C++, Fortran, Pascal, Eiffel, Basic, COBOL, ActionScript, Java Script, Objective C, etc., or any of a variety of combinations thereof. The computer-readable medium on which such instructions are stored may reside on one or more of the components of a general-purpose computer described above, and may be distributed across one or more of such components.

The computer-readable medium may be transportable such that the instructions stored thereon can be loaded onto any computer system resource to implement the aspects of the present invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above discussed aspects of the present invention.

Various embodiments according to the invention may be implemented on one or more computer systems, e.g. system 40000, FIG. 400. These computer systems may be, for example, general-purpose computers such as those based on Intel PENTIUM-type processor, Motorola PowerPC, Sun UltraSPARC, Hewlett-Packard PA-RISC processors, or any other type of processor. As well, these computer systems may be hand held mobile devices, like smartphones and tablets such as those based on ARM processors, or any other type of processor.

It should be appreciated that one or more of any type computer system may be used to partially or fully automate play of the described game according to various embodiments of the invention. Further, the software design system may be located on a single computer or may be distributed among a plurality of computers attached by a communications network.

The computer system 40000 may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

The computer system 40000 includes a processor 40006 connected to memory device 40010. Memory 40010 is typically used for storing programs and data during operation of the computer system 40000. Components of computer system 40000 are coupled by an interconnection mechanism 40008. The interconnection mechanism 40008 enables communications to be exchanged between system components of system 40000. Computer system 40000 also includes one or more input device 40004, output device 40002 for user interface with computer system 40000.

Storage device 40012, shown in greater detail in FIG. 410, typically includes a computer readable and writeable nonvolatile recording medium 41002 in which signals are stored that define a program to be executed by the processor or information stored on or in the medium 41002 to be processed by the program. Typically, in operation, the processor 40006 causes data to be read from the nonvolatile recording medium 41002 into another memory 41004 that allows for faster access to the information by the processor than does the medium 41002. This memory 41004 includes a volatile, random access memory such as a dynamic random access memory (DRAM) or static memory (SRAM). Processor 40006 generally manipulates the data within the integrated circuit memory 40010, 41004 and then copies the data to the medium 41002 after processing is completed.

A computer system may be a general-purpose computer system that is programmable using a high-level computer programming language. Computer system may be a handheld mobile device, like a smartphone or tablet as well. Computer system may be also implemented using specially programmed, special purpose hardware. In a computer system there may be a processor that is typically a commercially available processor such as the well-known Pentium class processor available from the Intel Corporation. Many other processors are available. Such a processor usually executes an operating system which may be, for example, the Windows 95, Windows 98, Windows NT, Windows 2000 (Windows ME), Windows XP, or Windows Visa operating systems available from the Microsoft Corporation, MAC OS System X available from Apple Computer, the Solaris Operating System available from Sun Microsystems, IOS from apple, Android from Google, or UNIX available from various sources. Many other operating systems may be used. The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems (42004-42008) coupled to a communications network, e.g. FIG. 420, 42002. These computer systems also may be general-purpose computer systems, e.g. 40000. For example, various aspects of the invention may be distributed among one or more computer systems configured to provide a service (e.g., servers) to one or more client computers, or to perform an overall task as part of a distributed system, e.g. 42000. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java, C++, Ada, Objective C, ActionScript, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

Having now described some illustrative embodiments of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments. Further, for the one or more means-plus-function limitations recited in the following claims, the means are not intended to be limited to the means disclosed herein for performing the recited function, but are intended to cover in scope any means, known now or later developed, for performing the recited function.

As used herein, whether in the written description or the claims, the terms “comprising”, “including”, “containing”, “characterized by” and the like are to be understood to be open-ended, i.e., to mean including but not limited to. Only the transitional phrases “consisting of” and “consisting essentially of”, respectively, shall be closed or semi-closed transitional phrases, as set forth, with respect to claims, in the United States Patent Office Manual of Patent Examining Procedures (Eighth Edition 2nd Revision, May 2004), Section 2111.03.

Use of ordinal terms such as “first” “second” “third” “a” “b” “c” etc., in the claims to modify or otherwise identify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A computer implemented method for providing pile manipulation functionality, the method comprising:
providing, via a display device, to a player a view of one or more piles of stacked, approximately rectangular objects;
determining, by executing instructions stored in a memory device, for a predetermined group size, per pile, a grouping of said approximately rectangular objects from bottom up into consecutive groups with said predetermined group size, allowing only the top group to contain less of said approximately rectangular objects than said predetermined group size;
displaying, via said display device, said groupings to said player, by representing each of these groupings by a container, each of them having a shape that delimits a space in which approximately fits an amount of said approximately rectangular objects that is equal to said predetermined group size;
determining, processing input from an input device by executing instructions stored in a memory device, whether said player initiates a drag and drop transfer of one or more selected objects, being either an instance of one of said containers, selected from one of said piles, or a subgroup of one or more of said approximately rectangular objects, selected from the top container of one of said piles;
determining, processing input from an input device by executing instructions stored in a memory device, whether said player that initiated said drag and drop transfer ends his drag and drop action;
stacking, by executing instructions stored in a memory device, said selected container on the top of the pile said selected container is hovering over, for the case that said player ends the drag and drop action for said selected container while said selected container is hovering over another pile than the pile that it was selected from during said drag and drop transfer initiation, and said other pile is not comprising any partly empty containers, which are containers that have empty slots for one or more of said approximately rectangular objects;
inserting, by executing instructions stored in a memory device, said selected container below the partly empty container at the top of the pile which said selected container is hovering over, for the case that said selected container is completely filled with said approximately rectangular objects and that said player ends the drag and drop action for said selected container while said selected container is hovering over another pile than the pile that it was selected from during said drag and drop transfer initiation, and said other pile has a partly empty container at its top; by executing instructions stored in a memory device, to accommodate for the space required for said insertion, said partly filled container is moved up;
stacking, by executing instructions stored in a memory device, said approximately rectangular objects from said selected container, into the top container at the top of a drop off pile, and stacking any surplus that does not fit into that top container into a newly created container that is stacked on top of said drop off pile, provided that the selected container is partly empty, and said drop off pile is valid, whereby a valid drop off pile is a pile that said selected container is hovering over when said player ends his drag and drop action, while at the same time that pile is another pile than the pile said selected container was selected from during said drag and drop transfer initiation;
stacking, by executing instructions stored in a memory device, the approximately rectangular objects from said selected subgroup, into the top container at the top of said drop off pile, and stacking any surplus that does not fit into that top container into a newly created container that is stacked on top of said drop off pile, provided that said drop off pile is valid, whereby a valid drop off pile is a pile that said selected subgroup is hovering over when said player ends his drag and drop action, while at the same time that pile is another pile than the pile said selected subgroup was selected from during said drag and drop transfer initiation.

2. The method according to claim 1, wherein displaying, via said display device, count helpers for each container, whereby each count helper comprises one or more shapes that facilitate said player to count the amount of said approximately rectangular objects that are contained in the container that the count helper is associated with.

3. The method according to claim 2, wherein said count helpers each comprise an approximately diamond shaped delineation.

4. The method according to claim 3, wherein each corner of said approximately diamond shaped delineation is positioned at a distance from the center of the overlaid container that equals approximately three times the height of one of said approximately rectangular objects.

5. The method according to claim 2, wherein said count helpers each comprise a semi-transparent approximately rectangular shape that approximately overlays the bottom half of the locations in said container where said approximately rectangular objects may be held.

6. The method according to claim 1, wherein empty slots inside said containers are being emphasized by shapes that have approximately the same size and shape as said approximately rectangular objects.

7. The method according to claim 1, wherein empty slots inside said containers are being emphasized by delineations that accentuate the approximate bounds of the regions that are reserved to hold individual instances of said approximately rectangular objects.

8. The method according to claim 1, wherein displaying via said display device, digits are being displayed below one or more piles, associating the pile with a numerical value.

9. The method according to claim 1, wherein displaying via said display device, fractional numbers are being displayed below one or more piles, associating the pile with a numeric value.

10. The method according to claim 1, wherein restoring, by executing instructions stored in a memory device, all piles to the state they had prior to said transfer initiation in the case that said player ends the drag and drop action while said selected objects are not hovering over another pile than the pile that said selected objects were selected from during said transfer initiation.

11. The method according to claim 1, wherein displaying via said display device, pile location indicators, which are graphical widgets that indicate locations upon which piles of containers can be stacked.

12. The method according to claim 1, wherein any containers that are at the top of a pile are being displayed with an opened top.

13. The method according to claim 1, wherein being displayed via said display device, said containers have an approximately square shaped appearance.

14. The method according to claim 1, wherein said approximately rectangular objects are being represented as 3D, approximately bar shaped objects on the display device.

15. The method according to claim 1, wherein by executing instructions stored in a memory device, at the location that said selected container was selected from during transfer initiation, a ghost copy of said selected container is inserted, which is removed after said player has ended the drag and drop action of said selected container, whereby said ghost copy comprises a transparent and/or color transformed copy of said selected container.

16. The method according to claim 1, wherein one of the piles is bestowed with reservoir properties; A pile that is bestowed with said reservoir properties comprises a single container that is full of said approximately rectangular objects of a predetermined color; The player can drag said single container or groups of said approximately rectangular objects from said pile that is bestowed with said reservoir properties, whereafter by executing instructions stored in a memory device, said pile that is bestowed with said reservoir properties automatically replenishes itself.

17. The method according to claim 1, wherein one of the piles is bestowed with trash can properties; The player can drag said containers or groups of said approximately rectangular objects toward said pile that is bestowed with said trash can properties, resulting, by executing instructions stored in a memory device, in the destruction of these objects.

18. The method according to claim 1, wherein multiple types of said approximately rectangular objects are being used, each with a different predetermined graphical representation.

19. The method according to claim 1, wherein:
displaying, via said display device, count helpers for each container, whereby each count helper comprises one or more shapes that facilitate said player to count the amount of said approximately rectangular objects that are contained in the container that the count helper is associated with;
empty slots inside said containers are being emphasized by delineations that accentuate the approximate bounds of the regions that are reserved to hold individual instances of said approximately rectangular objects;
displaying via said display device, digits are being displayed below one or more piles, associating the pile with a numerical value;
restoring, by executing instructions stored in a memory device, all piles to the state they had prior to said transfer initiation in the case that said player ends the drag and drop action while said selected objects are not hovering over another pile than the pile that said selected objects were selected from during said transfer initiation;
displaying via said display device, pile location indicators, which are graphical widgets that indicate locations upon which piles of containers can be stacked;
being displayed via said display device, said containers have an approximately square shaped appearance.

20. A non-transitory computer-readable medium having computer-readable signals stored thereon that define instructions that, as a result of being executed by a computer, instruct the computer to perform a method providing pile manipulation functionality, the method comprising:
providing, via a display device, to a player a view of one or more piles of stacked, approximately rectangular objects;
determining, by executing instructions stored in a memory device, for a predetermined group size, per pile, a grouping of said approximately rectangular objects from bottom up into consecutive groups with said predetermined group size, allowing only the top group to contain less of said approximately rectangular objects than said predetermined group size;
displaying, via said display device, said groupings to said player, by representing each of these groupings by a container, each of them having a shape that delimits a space in which approximately fits an amount of said approximately rectangular objects that is equal to said predetermined group size;
determining, processing input from an input device by executing instructions stored in a memory device, whether said player initiates a drag and drop transfer of one or more selected objects, being either an instance of one of said containers, selected from one of said piles, or a subgroup of one or more of said approximately rectangular objects, selected from the top container of one of said piles;
determining, processing input from an input device by executing instructions stored in a memory device, whether said player that initiated said drag and drop transfer ends his drag and drop action;
stacking, by executing instructions stored in a memory device, said selected container on the top of the pile said selected container is hovering over, for the case that said player ends the drag and drop action for said selected container while said selected container is hovering over another pile than the pile that it was selected from during said drag and drop transfer initiation, and said other pile is not comprising any partly empty containers, which are containers that have empty slots for one or more of said approximately rectangular objects;
inserting, by executing instructions stored in a memory device, said selected container below the partly empty container at the top of the pile which said selected container is hovering over, for the case that said selected container is completely filled with said approximately rectangular objects and that said player ends the drag and drop action for said selected container while said selected container is hovering over another pile than the pile that it was selected from during said drag and drop transfer initiation, and said other pile has a partly empty container at its top; by executing instructions stored in a memory device, to accommodate for the space required for said insertion, said partly filled container is moved up;
stacking, by executing instructions stored in a memory device, said approximately rectangular objects from said selected container, into the top container at the top of a drop off pile, and stacking any surplus that does not fit into that top container into a newly created container that is stacked on top of said drop off pile, provided that the selected container is partly empty, and said drop off pile is valid, whereby a valid drop off pile is a pile that said selected container is hovering over when said player ends his drag and drop action, while at the same time that pile is another pile than the pile said selected container was selected from during said drag and drop transfer initiation;
stacking, by executing instructions stored in a memory device, the approximately rectangular objects from said selected subgroup, into the top container at the top of said drop off pile, and stacking any surplus that does not fit into that top container into a newly created container that is stacked on top of said drop off pile, provided that said drop off pile is valid, whereby a valid drop off pile is a pile that said selected subgroup is hovering over when said player ends his drag and drop action, while at the same time that pile is another pile than the pile said selected subgroup was selected from during said drag and drop transfer initiation.
